(19) United States
(12) Patent Application Publication
(10) Pub. No.: US 2005/0001840 A1
(43) Pub. Date: Jan. 6, 2005

(54) Using line struture information to enhance line drawing in digital systems

(76) Inventors: Peter Stephenson, Providence, RI (US); Bruce Litow, Kirwan (AU); Nicholas Diakopoulos, E. Greenwich, RI (US)

Correspondence Address: GORDON E NELSON;PATENT ATTORNEY, PC, 57 CENTRAL ST, PO BOX 782, ROWLEY, MA, 01969, US

(21) Appl. No.: 10/498,467

(22) PCT Filed: Dec. 12, 2002
(86) PCT No.: PCT/US02/39716

Related U.S. Application Data
(60) Provisional application No. 60/341,503, filed on Dec. 13, 2001.
(60) Provisional application No. 60/341,194, filed on Dec. 13, 2001.

(51) Int. Cl. G06T 11/20; G09G 5/00

(52) U.S. Cl. 345/443; 345/611

(57) ABSTRACT

Line drawing techniques that employ runs or runs of runs of pixels to draw the line compute line structure information that they use to determine the sequence of runs in the line. This line structure information may be used in other ways to enhance the line drawing operation. One of the ways is to use the line structure information to compute the positions of a plurality of the runs and then draw the runs in parallel. Another way is to use the line structure information to determine properties of sets of cells that include not only cells of the run, but additional cells that are affected by the presence of the cells of the run. One example of such sets of cells is the cells of the run plus anti-aliasing cells. The line structure information can be used to determine the location and size of a set of cells and the intensities of the anti-aliasing cells. Another example of such sets of cells are cells that are written together in a single memory operation. The sets of cells may be drawn in parallel in the same fashion as the runs.

### CROSS REFERENCES TO RELATED APPLICATIONS

The present patent application claims priority from PCT/US02/24711, Stephenson, et al., Methods and apparatus for determining intersections of a particular line with cells in a lattice filed 2 Aug. 2002, which in turn claims priority from U.S. provisional patent application 60/309,926, Stephenson, et al., Process and apparatus for line drawing, filed 3 Aug. 2001. In the US national stage, this application will be a continuation-in-part of PCT/US02/24711. This application further claims priority from U.S. provisional patent application 60/341,503, Stephenson, et al., Process and apparatus for anti-aliased line drawing, filed 13 Dec. 2001, and U.S. provisional patent application 60/341,194, Stephenson, et al., Process and apparatus for line drawing in parallel, also filed 13 Dec. 2001. This application contains the entire Detailed Description of PCT/US02/24711; the new material begins with the section titled Additional line drawing techniques that use the line structure information.

### BACKGROUND OF THE INVENTION

1. Field of the Invention

The invention relates generally to techniques for determining which cells of a raster are intersected by a particular line. The cells of the raster are represented in the memory of a computer system and the determination is made by the computer system's processor. The cells of the raster may generally represent a set of locations. The locations may be pixels in a display, and when they are, the techniques may be used to determine which pixels in the display represent the particular line, and thus to generate the line in the display.

2. Description of Related Art: FIGS. 9-11

Systems Using Raster Display Devices. FIG. 9

The flat panel or cathode ray tube display devices typically used with computer systems are raster devices, that is, the display area is made up of a large number of picture elements, or pixels, which are arranged in a grid. The location of any pixel in the display can be specified by its row and column in the grid. The image that the display device displays is made by varying the color and intensity of the pixels in the grid.

FIG. 9 is a high-level overview of a computer system with a raster display device. The main components of system 901 are a processor 911 with memory 903 to which processor 903 has access and a monitor 915 for which processor 911 generates displays. Monitor 915 is a raster display device and as such, has a grid of pixels 917. Within memory 903 are stored bitmap 909, bitmap drawing code 985, and bitmap data 907. Bitmap 909 is an area of memory that corresponds to grid of pixels 917. Each item of data in bitmap 909 corresponds to a pixel in grid of pixels 917. Drawing code 985 is code for drawing graphical entities such as lines or polygons in bitmap 909. Bitmap data 907, finally, is data, typically supplied by a user program, which bitmap drawing code 985 uses to draw a graphical entity. For example, if a user program wishes to specify a line, it will typically indicate the start and end coordinates of the line in grid of pixels 917 and drawing code 985 will use that information to draw a corresponding line in bitmap 909. Processor 911 then reads from bitmap 909 to generate an image for display on grid of pixels 917. In many cases, a display generator component 913 of processor 911 reads bitmap 909 and produces the actual signals for monitor 915 from the data in bitmap 909. It should be noted here that the task of producing a display 917 may be distributed in many different ways across hardware and software components, with the amount of hardware increasing as performance demands increase.

Representing Lines Using Pixels: FIG. 10

Drawing straight lines is a problem with any raster display device. FIG. 10 shows why. FIG. 10 shows a representation in pixels 1001 of the line 1003 that is described by the equation

$$y = \frac{17}{41} x .$$

The representation includes those pixels in the grid that are intersected by line 1003. These pixels form a pattern 1004 that is termed the intersection pattern for the line. A line's intersection pattern depends not only on the line's slope, but also on the location of its endpoints relative to the grid of pixels. As will be explained in more detail in the following, the intersection pattern for any straight line has regular features that can be used in drawing the straight line in a raster display or analyzing a straight line that is displayed in a raster display.

At its lowest level, the intersection pattern for line 1003 is a sequence of pixels. For a given next pixel, there are only two possibilities: if the current pixel has the coordinates (a,b), the next pixel has either the coordinates (a+1,b) or (a+1,b+1). Which of the two possibilities the next pixel has depends on where the line intersects the current pixel. To draw a line one pixel at a time, one need only determine for each pixel where the line intersects the current pixel and use that information to determine which of the two possible positions to give the next pixel.

As is apparent from FIG. 10, the intersection pattern includes groups of adjacent pixels that have the same y coordinate. Such a group of pixels is called a run. One such run of three pixels is shown at 1005. An examination of the runs in FIG. 10 shows that they have only two lengths: a short length 107, which is here two pixels, and a long length 1009, which is here three pixels. The general rule is that the runs of an intersection pattern will have only two lengths, and these lengths will be consecutive integers. The lengths of the long and short runs for any given line can be computed as follows: Within the intersection pattern of the line

$$l \text{:} y = \frac{a}{d} x ,$$

there are a runs that correspond to the Y-axis size of the lattice. As there are only two possible run lengths in a given intersection pattern and the possible lengths are consecutive integers we will refer to the lengths as short (s) and long (l). To determine what run lengths are possible within the intersection pattern, consider that there are d pixels to be distributed among a runs, the distribution being as even as possible. If we divide up the d pixels into a runs of length

$$r = ⌊ \frac{d}{a} ⌋$$

we have n=d mod a pixels remaining, 0≦n<a, which have to be distributed along the intersection pattern. Therefore in the intersection pattern of l there are n long runs each with r+1 pixels and a-n short runs with r pixels each.

This can be applied to line 1003 as follows: line 1003 contains 41 pixels and 17 runs. The possible run lengths are

$$r = ⌊ \frac{41}{17} ⌋ = 2$$

and r+1=3. There are 41 mod 17=7 long runs 1009 of length three shown in light gray and 17-7=10 short runs 1007 of length two shown in dark gray. Therefore using a run-based algorithm improves upon pixel-based algorithms as only a and not d decisions whether to increase the y coordinate by 1 are necessary.

An examination of intersection pattern 1004 of line 1003 shows that the long and short runs themselves occur in repeating patterns. Thus, in intersection pattern 1004, there is a repeating pattern of a long run (I) followed by two short runs (s) followed by a long run followed by one short run, or lssls, as shown at 1011 and 1013. In general, there are four possibilities for the patterns of runs:
ls⁺, a long run followed by one or more short runs;
l⁺s, one or more long runs followed by a short run;
sl⁺, a short run followed by one or more long runs; and
s⁺l, one or more short runs followed by a long run.

These patterns are termed in the following the shapes of runs. Thus, using this notation, the shape of the runs shown at 1011 and 1013 is ls⁺. Moreover, it turns out that the first run in the intersection pattern of the line

$$l \text{:} y = \frac{a}{d} x$$

must be long. Therefore we need only two shapes: ls⁺and l⁺s to describe the intersection patterns of a line. ls⁺applies when there are more short runs than long runs in the intersection pattern and l⁺s when there are more long runs than short. In the case where there are equal numbers of runs, the two cases are equivalent.

The properties just described also apply to runs of runs. For example in intersection pattern 1004, the complete sequence of runs is lslslsslslsslslss; therefore we have singularly occurring runs l separating sequences of shorts runs s⁺ and the intersection pattern is constructed of runs of runs with the shape ls⁺. The terminology of runs of runs is cumbersome so let us define these runs of runs to be second order runs. Where a run is defined by its position and length, a second order run is defined by its position, its length is defined by the number of runs which comprise it, and its shape is determined by whether there are more long or short runs in the pattern. By analogy with second order runs, we can define runs to be first order runs and pixels to be zero order runs.

To determine the possible lengths of the second order runs let us consider the case where there are more short runs than long and continue the use of our example. In this case, the number of second order runs must be the same as the number of long runs in the pattern by definition. If there are n long runs in the line there are a runs to divide amongst n second order runs. Therefore if the division is to be as even as possible the length of a short second order run, r^{[2]}, will be

$${r}^{[ 2 ]} = ⌊ \frac{a}{n} ⌋ .$$

There will be n^{[2]}≡a mod n long runs and a-n^{[2]} short runs of order 2. The second order runs appear at 1011 and 1013 in intersection pattern 1004. There are more short runs 1013 than long, so the second order runs have the shape ls⁺, i.e., one long run followed by a sequence of short runs. There are three long runs 1011 of length three and four short runs 1013 of length two.

There is no reason to end this hierarchical description at order 2. We can define a recursive hierarchical description of the intersection pattern of the line l based on defining runs of higher order. For orders three and above, there is no restriction that the first run in the intersection pattern must be long and therefore all four possible shapes can occur. For order i, if there are more short runs of order i−1 in the intersection pattern, the shape of the order i runs will be s⁺l or ls⁺. If there are more long runs of order i−1, the shape will be l⁺s or ls⁺. An example of third order runs in the intersection pattern 1004 is shown at 1015 and 1017. There are three runs of order 3 amongst which the seven runs of order 2 are to be distributed as evenly as possible.

Therefore the length of a short run of order 3 is

$${r}^{[ 3 ]} = ⌊ \frac{7}{3} ⌋ = 2 ,$$

and amongst the three order 3 runs, there will be 7 mod 3≡1 long run of length r^{[3]}+1=3. The shape of the order 3 runs is s⁺l. For lines with a rational slope, the hierarchical description of ordered runs within the intersection pattern will be bounded, as the intersection pattern is eventually repeated if a and d are not coprime.

For the example line 1003

$$l \text{:} y = \frac{17}{41} x ,$$

the process reaches its conclusion at order 4. There are three order 3 runs, of which one is long and two are short. There will be therefore one order 4 run containing all three order 3 runs and starting with the only long order 3 run. The order 4 run is the entire intersection pattern of the line

$$l \text{:} y = \frac{17}{41} x$$

and the lattice [symbol] (41,17).
Dealing With Lines Which do not Intersect the Origin: FIG. 11

Introducing a non-zero intercept to a line with rational slope presents a number of complications. Consider the line

$$l \text{:} y = \frac{a}{d} x + β$$

where a and d are coprime. Within the frame of the lattice [symbol] _{(d,a)}, the line y forms an intersection pattern that is repeated throughout the infinite intersection pattern defined upon the unbounded lattice. Therefore we will only consider the intersection pattern [symbol] , within the frame [symbol] _{(d,a)}.

Let us consider first the line l:

$$y = \frac{a}{d} x + β$$

where β=0. Within the frame [symbol] _{(d,a)}, the vertical distance the line l is above any lattice point within the intersection pattern is

$$\frac{{b}_{j}^{[ 0 ]}}{d}$$

where
bⱼ^{[0]}=0, . . . , d−1 where the values bⱼ^{[0]} are those values of the order 0 numerator sequence. The numerator sequence is a sequence of the numerators of the fractions

$$\frac{{b}_{j}^{[ 0 ]}}{d} .$$

These fractions specify the point in the left edge of the pixel at which the line intersects the pixel. Therefore the line is at least

$$\frac{1}{d}$$

from any lattice point. If the value of β is raised slowly, the intersection pattern will remain unchanged until the line crosses or intersects a lattice point. Therefore the first change will occur when

$$β = \frac{1}{d} .$$

Let the lattice point intersected be (xₕ,yₕ)

As the line

$${l}^{′} \text{:} y = \frac{a}{d} x + β$$

intersects the point (xₕ,yₕ) and the line

$$l \text{:} y = \frac{a}{d} x$$

intersects the origin, the intersection pattern [symbol] , of the line l′ will be identical to the intersection pattern [symbol] , of the line l translated by (xₕ,yₕ). Therefore the introduction of an intercept to a line with rational slope will, more often than not, cause a shifting of the intersection pattern of the line. The key values of the intercept at which this translation of the intersection pattern occurs are

$$β = \frac{1}{d}$$

where b=0, . . . ,d−1.

FIG. 11 gives an example. At 1001, the figure shows the intersection pattern of the line

$$l \text{:} y = \frac{17}{41} x .$$

At 1101, the figure shows the effect of introducing an intercept value of

$$\frac{23}{41}$$

on the interception pattern. The numerator sequence for order 0 of 1001 is shown at 1109 and that for order 0 of 1101 at 1111.

Given that the numerator of the intercept is b=23, we have demarcated the pixels before (1103) and after (1104) b=23 in order 0 numerator sequence 1109 by a dashed line 1102. The pixels 1104 to the right of this value are denoted by light gray and the pixels 1103 to the left by dark gray. At 1101, we can see that adding the intercept value

$$\frac{23}{41}$$

shifts the light gray pixels 1104 to the beginning of the intersection pattern, [symbol] . The dark gray pixels 1103 now form the end of the pattern [symbol] . Coinciding with the shift in pixels, the values of numerator sequence of order 0 1111 are also shifted and now start with a value of b₀^{[0]}=b=23. The shifting of the runs of all orders in the intersection pattern with the introduction of a non-zero intercept is mimicked by the shift in the values of the numerator sequence.

The shifting of the intersection pattern due to the introduction of a non-zero intercept has a number of side effects. The initial and final run of any order may be truncated. This occurs when the numerator of the intercept is not in the numerator sequence of that order. A run order is split and forms the initial and final partial run. If the numerator sequence is to be calculated for this order, the initial numerator value will have to be calculated. For example, at 1101, the numerator value of the intercept is b=23. We know that all of the numerator values of order 1 are less than p^{[1]=α=}17. Therefore the initial value of the order 0 numerator sequence will not be the same as the initial value of the order 1 numerator sequence and the initial and final runs of order 1 will be truncated.

Using Hierarchies of Runs to Generate Lines

There are many line drawing techniques that take advantage of the structure of a line's intersection pattern. At the pixel level, the standard line drawing algorithm of Bresenham may be employed. In this algorithm, the point at which the line intersects the current pixel determines whether the next pixel's y coordinate is incremented by 1. See J. E. Bresenham, “An incremental algorithm for digital plotting”, ACM National Conference, August 1963. Bresenham's algorithm may be used only with lines whose start and end coordinates are rational numbers. Where the starting and end coordinates may be any real number, the well-known DDA algorithm must be used. See A. Van Dam, J. Foley, S. Feiner and J. Hughes, Computer Graphics: Principles and Practice, Second Edition in C, Addison-Wesley (1995). Like Bresenham's algorithm, DDA works at the pixel level. Initially, floating-point x and y increments are computed. The x increment is the difference between the ending and starting x coordinates divided by the line's length and the y increment is the difference between the ending and starting y coordinates divided by the line's length. Each time a pixel is set, the current x and y coordinates, which are floating point values, are converted to integers and the pixel is set at the cell defined by the increment. Then the x increment is added to the x coordinate and the y increment is added to the y coordinate. A difficulty with any pixel-by-pixel approach is that it requires a determination where the next pixel will be placed relative to the last pixel for each new pixel. With the DDA algorithm, this determination is a floating-point operation. As such, it is both expensive to perform and subject to rounding errors. Moreover, because the determination must be performed with every pixel, the rounding errors may accumulate quickly and cause the line to be drawn inaccurately.

The overhead of computing the location of the next pixel relative to the last is avoided in algorithms that use runs of pixels instead of individual pixels to draw the line. At the level of a run of order 1, Reggiori has developed an algorithm that determines the length of the next run in the line from the set of two possibilities. See G. B. Reggiori, “Digital computer transformations for irregular line drawings”, Technical Report 403-22, New York University, April 1972. Stephenson generalizes these techniques to the full hierarchy of runs in the line including runs of runs, runs of runs of runs, etc. See P. Stephenson, The structure of the digitized line, Ph.D thesis, James Cook University of North Queensland, 1998, which is incorporated by reference herein. Like Bresenham's algorithm, the algorithms that use runs and run hierarchies are limited to lines whose start and end points have rational number coordinates.

All of these algorithms possess a similar conditional structure regardless of whether they are based on pixels such as Bresenham's pixel-based algorithm or the DDA algorithm, runs such as Reggiori's algorithm, or a mixture of runs and runs of runs such as the run length slice algorithms. The slopes that are considered are bounded to lie in the range 0<α<1. For pixel-based algorithms that limits the choice of the next pixel to a possible set of two. For run-based algorithms, the choice is made between the two possible run lengths that can exist in the line. In all of these algorithms the choice is made by checking the value of a decision parameter against the value of zero. For values less than zero, one element of the possible set of choices is used; for values greater than zero, the other choice. For a value of zero, each technique handles this case differently. For line drawing applications, either choice is equally applicable and for ray tracing, this typically signifies a corner intersection.

An important advantage of run-based line drawing is that the structural information about the line that is used to determine which run length is to come next may also be used to accelerate other processes involved in drawing the line as well. In the following, three examples of such acceleration are given: parallelization of drawing full runs, using the structural information in adding anti-aliasing pixels to lines, and using the structural information to set lines in a memory that permits writing of blocks of contiguous pixels. It is thus an object of the present invention to provide improved techniques for drawing lines that are based on the structural information used to do run-based line drawing.

### SUMMARY OF THE INVENTION

One use of the structural information is to compute the positions of a plurality of sets of cells and then processing the sets of cells in parallel. The parallel processing may be done either by processing the sets of cells in parallel or by processing cells within the set of cells in parallel.

The sets of cells whose positions are computed may include cells belonging to a full run and may also include additional cells that are affected when a cell is intercepted by a line.

Another use of the structural information is to determine how to process additional cells that are affected by run-based line drawing. One example of such additional cells are anti-aliasing cells. The structural information may be used to determine the number and location of the anti-aliasing cells relative to the cells of a run and also to determine how the values of the pixels in the anti-aliasing cells are set. In the latter case, the values may be set in accordance with the value of an error term β that indicates where the line intersects the leading edge of the first cell in the run. The anti-aliasing cells may be added to the ends of the run, above or below the run, or both.

Such additional cells may also be involved in systems where a number of pixels are read from or written to memory in a single operation. In this case, the structural information can be used to determine how a chunk that contains cells of a run and/or anti-aliasing cells is to be written to the memory.

Sets of cells that include additional cells may of course be processed in parallel in the same fashion as sets of cells that include only the cells of a run.

Other objects and advantages will be apparent to those skilled in the arts to which the invention pertains upon perusal of the following Detailed Description and drawing, wherein:

### BRIEF DESCRIPTION OF THE DRAWING

FIG. 1 is an overview of the manner in which lines are drawn using the techniques of the invention;

FIG. 2 is an overview of a system which draws lines using the techniques of the invention;

FIG. 3 is a flowchart of how the bitmap processor processes complete runs of pixels;

FIG. 4 is a flowchart of how the bitmap processor processes truncated runs of pixels;

FIG. 5 is a flowchart of how the bitmap processor processes a run of order 1;

FIG. 6 is a flowchart of how the first truncated run of an order i is processed and set;

FIG. 7 shows how the first pixel of a line is handled using the techniques of the invention;

FIG. 8 shows a flowchart of how a complete run of order i is processed;

FIG. 9 shows a system in which the invention may be employed;

FIG. 10 shows the structure of a representation of a line as a set of pixels;

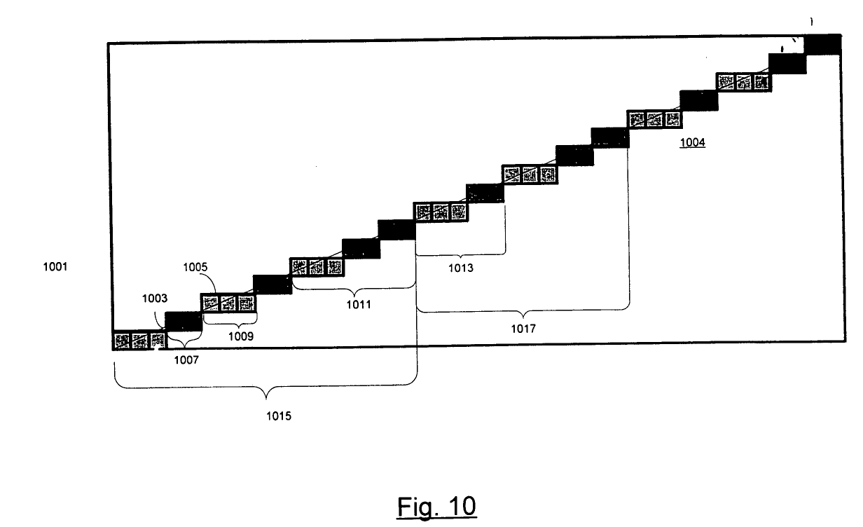

FIG. 11 shows the effect of a displacement of the starting point from the origin on the structure of the representation;

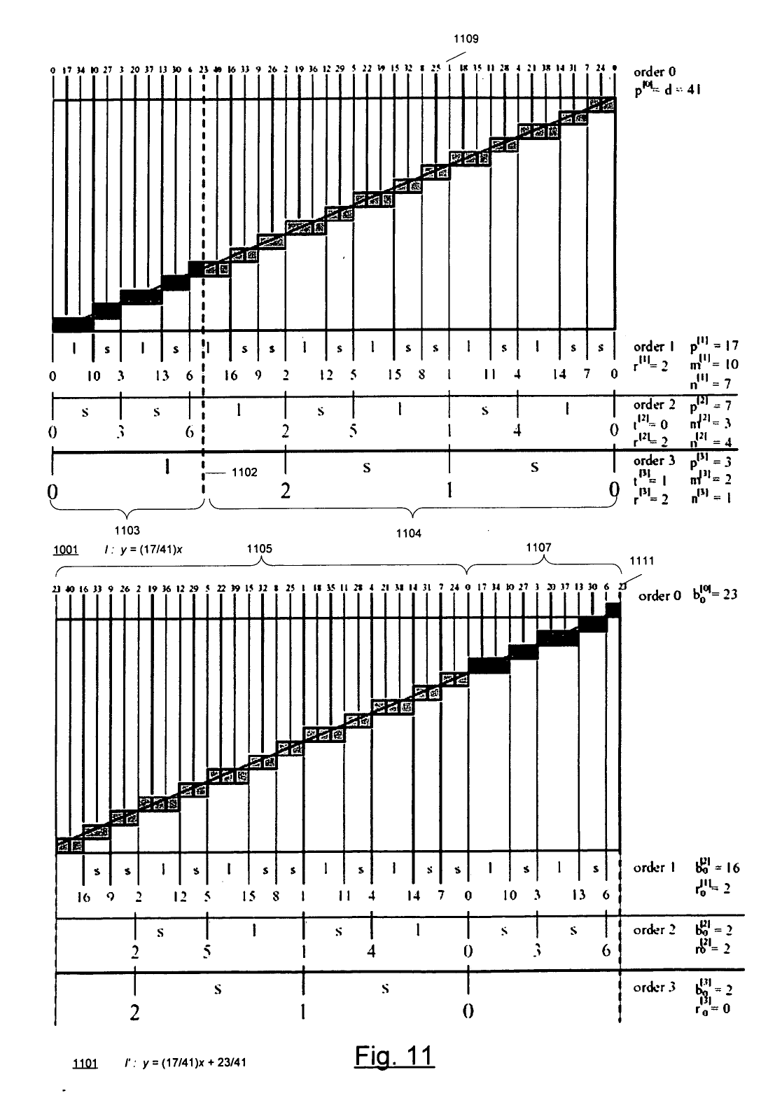

FIG. 12 shows an example line;

FIG. 13 shows how the first pixel of the example line is handled;

FIG. 14 shows truncated runs of orders 1-3 in the example line;

FIG. 15 shows the geometry of the error term and structural parameters id a run of order 1;

FIG. 16 is a flowchart of a technique for drawing lines in parallel;

FIG. 17 is a detail of an aliasing technique;

FIG. 18 shows three different anti-aliasing masks;

FIG. 19 shows lines drawn using anti-aliasing masks;

FIG. 20 is a graph showing speed of execution of line drawing using run masks;

FIG. 21 shows a line drawn using H1 and H3 anti-aliasing masks and details of the anti-aliasing masks; and

FIG. 22 shows how an anti-aliasing mask may be associated with a range of values oft.

### DETAILED DESCRIPTION

The following Detailed Description includes the complete Detailed Description of the parent of the present patent application; the disclosure which is new in this application begins at the section titled Additional line drawing techniques that use the line structure information.

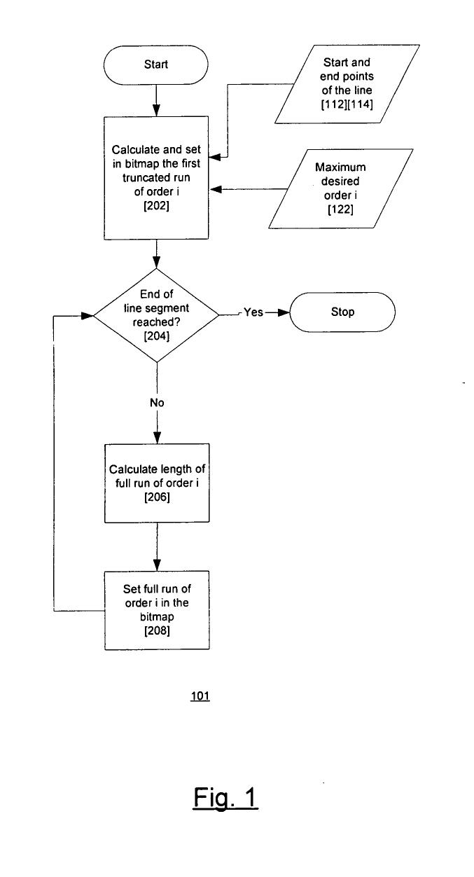

Overview of Line Drawing with the Invention: FIG. 1

FIG. 1 is a flowchart [101] that provides an overview of how a line segment may be drawn using this invention. Starting parameters include the maximum order of the runs to be used in drawing the lines [122] and the start and endpoints of the line [112,114]. The maximum order can be predefined by the manufacturer of an apparatus based on the invention, calculated based on the characteristics of the system or based on the length of the line. In the preferred embodiment the maximum order of the runs [120] is set to two.

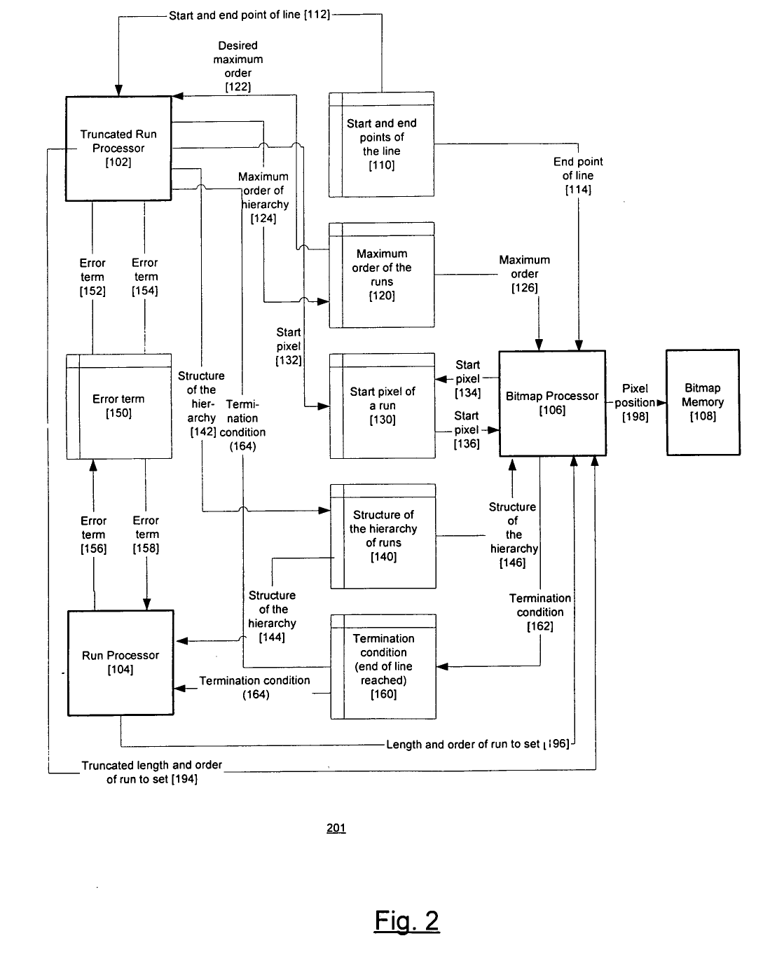

The line segment defined between the starting point [112] (x₀, y₀) and the end point [114] (x₁, y₁) consists of, at most, three sets of runs of any order, i. The first truncated run of order i, the set of full-length runs of order i, and the final truncated run of order i. To draw the line segment from (x₀, y₀) to (x₁, y₁), we will describe how to calculate and set in the Bitmap Memory [108]:
The first truncated run of order i [202].
The full length runs of order i [206].
The final truncated run of order i while setting the full length runs of order i [206].
   An alternative embodiment would calculate the first truncated run, each full length run and the final truncated run separately. Another alternative embodiment would have a desired maximum order [120] of infinity, and therefore the processing of the first truncated run length would draw the entire line segment unless the maximum depth of the hierarchy of runs was reached.
   Overview of the Components of a System for Drawing Lines According to the Invention: FIG. 2

FIG. 2 shows the components of a system 201 for drawing lines according to the invention. The main components of system 201 are a Truncated Run Processor [102], which calculates the structure of the first truncated run of order i [202] and the structure of the hierarchy of runs [140] in the line segment, and the Run Processor [104], which calculates the length of the full length runs and the final truncated run [206]. To set the runs [202][208] into the Bitmap Memory [108], the description of each run is given to the Bitmap Processor [106]. The Bitmap Processor is responsible for breaking the run into its composite pixels and setting each pixel into the Bitmap Memory [108].

Truncated Run Processor [102]

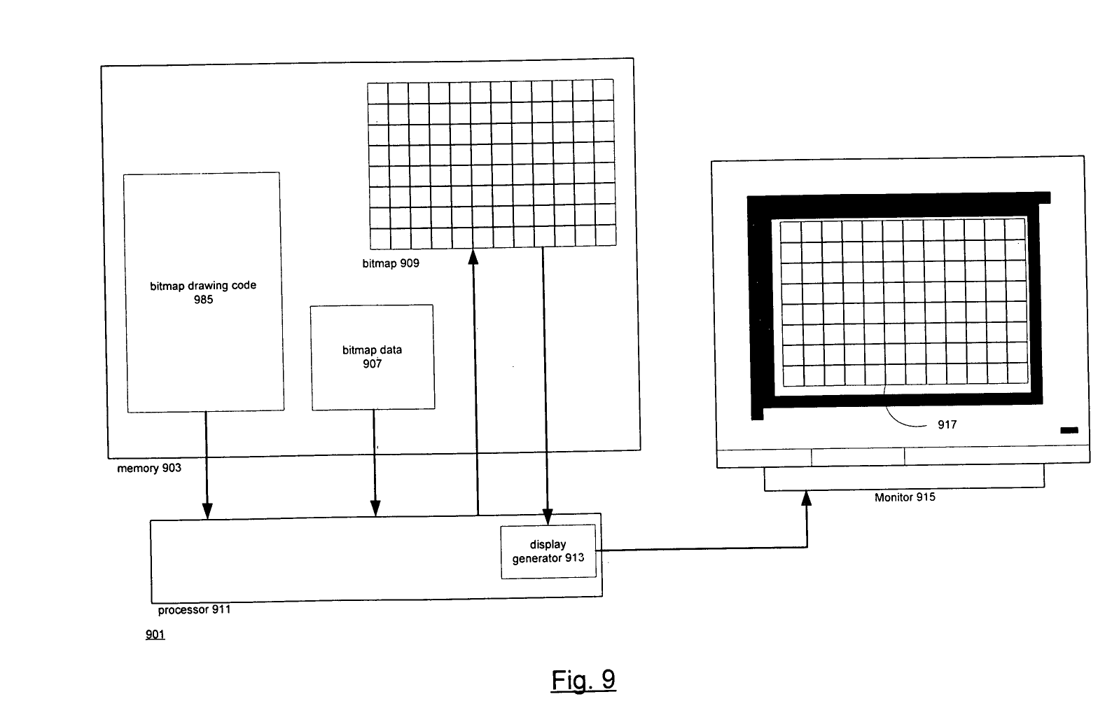

The Truncated Run Processor [102] is responsible for calculating the structure of the first truncated run of the desired order [120] and supplying this structure to the Bitmap Processor [106] so that the truncated run [194] can be set into the Bitmap Memory [108]. Bitmap memory [108] may be a bit map such as bitmap 909 in FIG. 9.

While the Truncated Run Processor calculates the structure of the first truncated run, it also calculates the structure of the hierarchy of runs [140] and stores this information [142] for the use by the Run and Memory Processors [104,106]. During this process if the desired maximum order of the process [120] is found to be greater than the maximum order of the hierarchy of runs in the line, the maximum order [120] is set to be the maximum depth of the hierarchy [124].

Based on the start and end points of the line [110], the Truncated Run Processor also calculates and stores [132] the starting pixel position for the line [130].

Each component of the first truncated run is calculated based on the error term [150]. As each component is processed the error term is retrieved [152], updated and stored again [154]. Once the first truncated run has been processed, the error term remaining [150] is used by the Run Processor [104] to define the full-length runs in a similar manner.

Run Processor [104]

The Run Processor [104] is responsible for calculating the length of each full-length run of the desired maximum order in the digital line. These lengths are passed to the Bitmap Processor [106] such that the runs can be set into the Bitmap Memory [108]. The length of the full-lengths is decided based on the error term [150], which is retrieved [156], updated and stored [158] to process the next full-length run. Thus, the error term is recalculated only at the beginning of each full-length run of the maximum order instead of for each pixel.

Bitmap Processor [106]

The Bitmap Processor [106] is responsible for actually setting the runs into the Bitmap Memory [108].

We assume there is a method to set a pixel of the memory to a desired value, similar to the setPixel(x, y, value) method described in the prior art. If a method to set a run of higher order, the Bitmap Processor [106] can take advantage of this function.

The Bitmap Processor [106] also keeps a track of the current position of the line being drawn in relation to the end point of the line [110]. If the line moves reaches the end point [114], the Bitmap Processor [106] signals the Truncated Run Processor [102] or the Run Processor [104] to terminate [162] using an internally stored termination condition [160].

Bitmap Memory [108]

The Bitmap Memory [108] is the memory representing the raster display of a graphics system, video memory, image memory or any other type of bitmap.

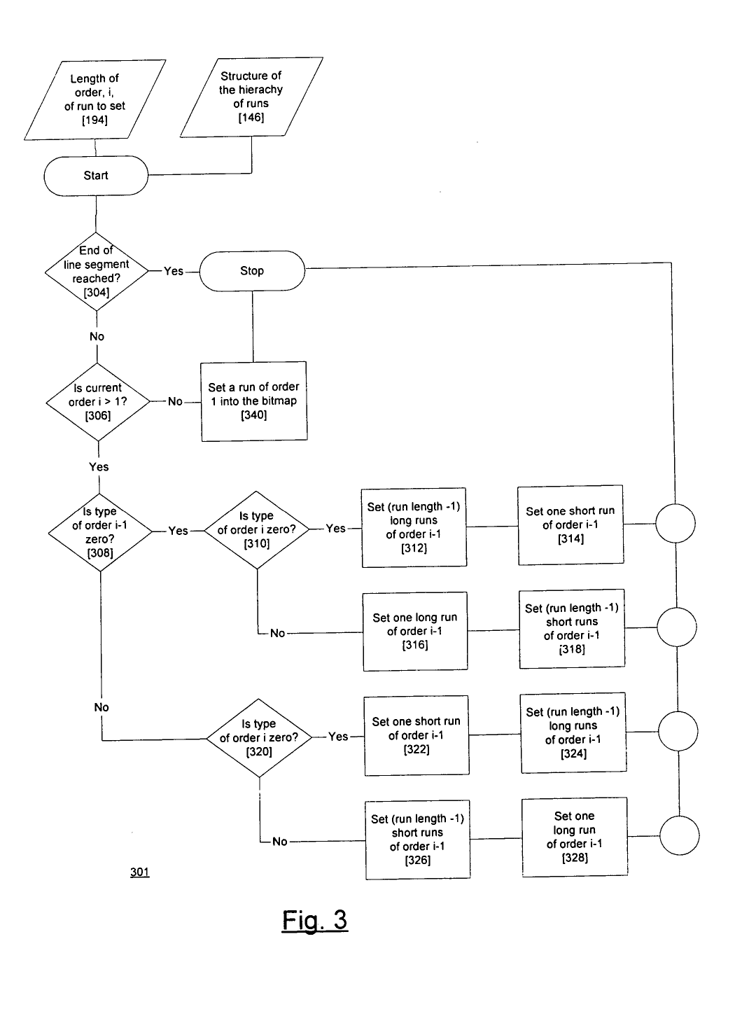

Details of Operation of the Components of System 201: FIGS. 3-8

For the remainder of this description we will describe:
1. How a truncated or full-length run of order i [202][208] is set into the Bitmap Memory [108] via the Bitmap Processor [106].
2. How the first truncated run of order i in the line segment is processed [202] by the Truncated Run Processor [102].
3. How the full-length runs of order i in the line segment [208] are processed by the Run Processor [104].
   How a Run of Order i is Set into the Bitmap Memory Via the Bitmap Processor: FIG. 3

The Bitmap Processor [106] handles the process of setting the pixels of the Bitmap Memory [108]. To draw the line, the Bitmap Processor is given a set of commands [194][196] to draw a collection of runs of various orders into the Bitmap Memory. The information given in the command to draw a run is the length of the run, rⱼ^{[i]}, and the order of the run, i [194][196]. The position of the run in the bitmap [130], (xⱼ^{[i]},yⱼ^{[i]}), is initialized [132] by the Truncated Run Processor [102] and is retrieved by the Bitmap Processor [136]. As the run is drawn, the coordinate is updated to the position of the next run of order i, and is stored for the next iteration [134].

The process of setting a run in the Bitmap Memory, involves reducing the run to a set of pixels and setting each individual pixel in the Bitmap Memory. Reducing the run of order i into runs of order 0 (pixels) is performed by recursively reducing the run of order k to runs of order k−1 for each order from k=i to k=2 resulting in a description of the run of order i in terms of runs of order 1. Each pixel in the run of order 1 is then set into memory.

We therefore describe:

How a full-length run of order i is reduced into runs of order i−1.
How the first truncated run of order i is reduced into runs of order i−1.
How the pixels of a run of order 1 are set into the Bitmap Memory.

In an alternative embodiment, if the Bitmap Memory [108] permits the setting of runs of pixels or runs of runs, etc., the process of reducing the run of order i to runs of order i−1 can be stopped at the permitted level. Therefore instead of setting pixels into the Bitmap Memory, runs or runs of runs can also be used.

Reducing a Full-length Run of Order k into Runs of Order k−1: FIG. 3

As described in the Description of related art, each run of any nonzero order i within the digital line has, at most, only two possible run lengths that are consecutive integers where the length is measured as the number of composite runs of the next lowest order, i=1. As a consequence of this, we can denote the occurrence of a short run by the symbol s and a long run by the symbol l. For example the runs of order 1 in the line segment (0, 0) to (41, 17) can be described by (lslslsslslsslslss)^{[l]}.

A run of order i can then be defined recursively by:
A run of order 1 is the maximal set of contiguous pixels with a similar abscissa.

A run of order i is the maximal set of contiguous runs of order i−1 such that each run has a shape (l⁺s)^{[i-1]}, (ls⁺)^{[i-1]}, (s⁺l)^{[i-1]}, or (sl⁺)^{[i-1]}, where (l⁺)^{[i-1]} and (s⁺)^{[i-1]} denote the occurrence of one or more long and short runs of order i−1 respectively.

We note that a run of order 2 can only possess the shape (l⁺s)^{[l]} or (ls⁺)[l].

Each run of any given order in the line segment has the same shape. To determine for a given order which of the four shapes is to be used, we define the runs of each order to have a type, t^{[i]}, which has a value 0 or 1. For a run of order i:
If t^{[i-1]}=0 and t^{[i]}=0 the shape of the run of order i is s^{[i]}=0:1⁺s.
If t^{[i-1]}=0 and t^{[i]}=1 the shape of the run of order i is s^{[i]}=1: ls⁺.
If t^{[i-1]}=1 and t^{[i]}=0 the shape of the run of order i is s^{[i]}=2: sl⁺.
If t^{[i-1]}=1 and t^{[i]}=1 the shape of the run of order i is s^{[i]}=3: s⁺l.

The type of order 1, t^{[l]}, is defined to be zero. The types of orders greater than 1 are calculated using structural parameters; the structural parameters and their calculation will be described in detail below.

To reduce a run of order i to the composite runs of order i−1, the procedure 301 shown in FIG. 3 is followed.

Inputs to the process are the length of the run of order i to be set [194] and the structure of the hierarchy of runs. The process will cease if the end point of the line has been reached [304].

If the order of the run is 1 [306], the pixels of the run are set directly [340] into the Bitmap Memory.

If the order of the run is at least 2, the run is reduced into its composite runs of the next lesser order and each run is set into the Bitmap Memory:
If t^{[i-1]}=0 and t^{[i]}=0 the shape of the run is s^{[i]}=0: l⁺s, therefore we set in order rⱼ^{[i]}−1 long runs of order i−1 (length rₗ^{[i-1]}=rₛ^{[i-1]}+1) and one short run of order i−1 (length rₛ^{[i-1]}).

This process follows the path from [308], [310], [312], [314].
If t^{[i-1]}=0 and t^{[i]}=1 the shape of the run is s^{[i]}=1: ls⁺, we set one long run of order i−1 (length rₗ^{[i-1]}=rₛ^{[i-1]}+1) and rⱼ^{[i]}−1 short runs of order i−1 (length rₛ^{[i-1]}).

This process follows the path from [308], [310], [316], [318].
If t^{[i-1]}=1 and t^{[i]}=0 the shape of the run is s^{[i]}=2: sl⁺, we set one short run of order i−1 (length rₛ^{[i-1]}) and rⱼ^{[i]}−1 long runs of order i−1 (length rₗ^{[i-1]}=rₛ^{[i-1]}+1).
This process follows the path from [308], [320], [322], [324].
If t^{[i-1]}=1 and t^{[i]}=1 the shape of the run is s^{[i]}]=3: s⁺l, we set rⱼ^{[i]}−1 short runs of order i−1 (length rₛ^{[i-1]}) and one long run of order i−1 (length rₗⁱ⁻¹=rₛ^{[i-1}+1).
This process follows the path from [308], [320], [326], [328].

The type and length of the short and long runs of any order are stored in the structure of the hierarchy of runs [146].

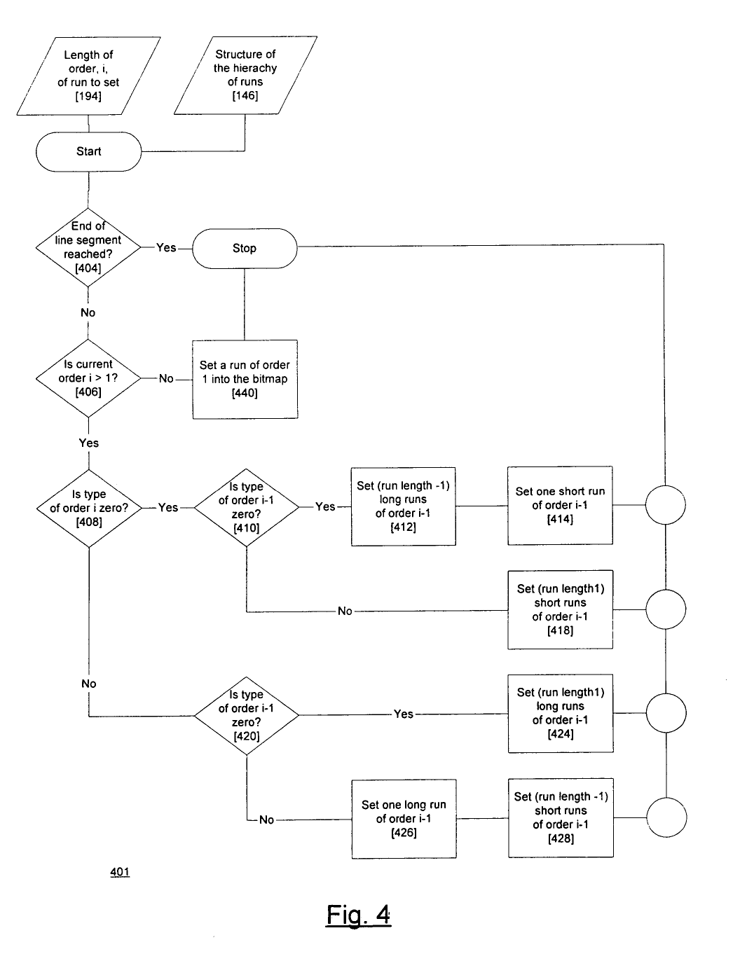

Reducing the First Truncated Run of Order k Into Runs of Order k−1: FIG. 4

The process of reducing the first truncated run of order k into full-length runs of order k−1 follows directly from the instructions to reduce full-length runs. The only variation comes from the fact that a truncated run is defined to be a run not of its full-length. Therefore at least one run of order k−1 has been truncated from the run of order k. Because this is the first run in the line, the truncated run occurs at the beginning of the run. In a preferred embodiment, the truncated runs received by the Bitmap Processor have a length of at least one. Therefore the only situations that need to be handled differently are when shapes s^{[i]}=1: ls⁺ and s^{[i]}=2: sl⁺occur.

The process is shown at 401 in FIG. 4. As with the process for a full-length run, the inputs are the length of the run of order i that is to be set [194] and the structure of the hierarchy of runs [146]. The process 401 will cease if the end point of the line has been reached [404].

If the order of the run is 1 [406], the pixels of the run are set directly [440] into the Bitmap Memory

If the order of the run is at least 2, the run is reduced into its composite runs of the next lesser order and each run is set into the Bitmap Memory:
If t^{[i-1]}=0 [408] and t^{[i]}=0 [410], the shape of the run is s^{[i]}=0: l⁺s. As the run is truncated, at least one run of order i−1 is removed from the beginning of the run. As the length of the truncated run is r₀^{[i]}, this leaves r₀^{[i]}−1 long runs of order i−1 and the final short run of order i−1. For example if the first run at full length is the sequence of runs (lllls)^{[i-1]} and the initial truncated run length is r₀^{[i]}=3, the truncated run comprises two long runs and the final short run of order i−1: (lls)^{[-1]}. Therefore to set the initial truncated run length, we set in order r₀^{[i]}−1 long runs of order i−1 (length rₗ^{[i-1]}=rₛ^{[i-]}+1) [412] and one short run of order i−1 (length rₛ^{[i]}) [414].
Similarly, if t^{[i-1]}=0 [408] and t^{[i]}=1 [410], the shape of the run is s^{[i]}=1:ls⁺. The truncated run has less runs than a short run of order i, therefore given the shape of the run ls+, there can only be short runs of order i−1 comprises the truncated run. Therefore we set r₀^{[i]} short runs of order i−1 (length rₛ^{[i-1]}) [418].
If t^{[i-1]}=1 [408] and t^{[i]}=0 [420] the shape of the run is s^{[i]}=2: sl⁺, we set r₀^{[i]} long runs of order i−1 (length rₗ^{[i-1]}=rₛ^{[i-1]}+1) [424].
If t^{[i-1]}=1 [408] and t^{[i]}=1 [420] the shape of the run is s^{[i]}=3: s⁺l, we set r₀^{[i]}−1 short runs of order i−1 (length rₛ^{[i-1]}) [426] and one long run of order i−1 (length rₗ^{[i-1]}=rₛ^{[i-1]+1}) [428].

The type and length of the short and long runs of any order are stored in the structure of the hierarchy of runs [146].

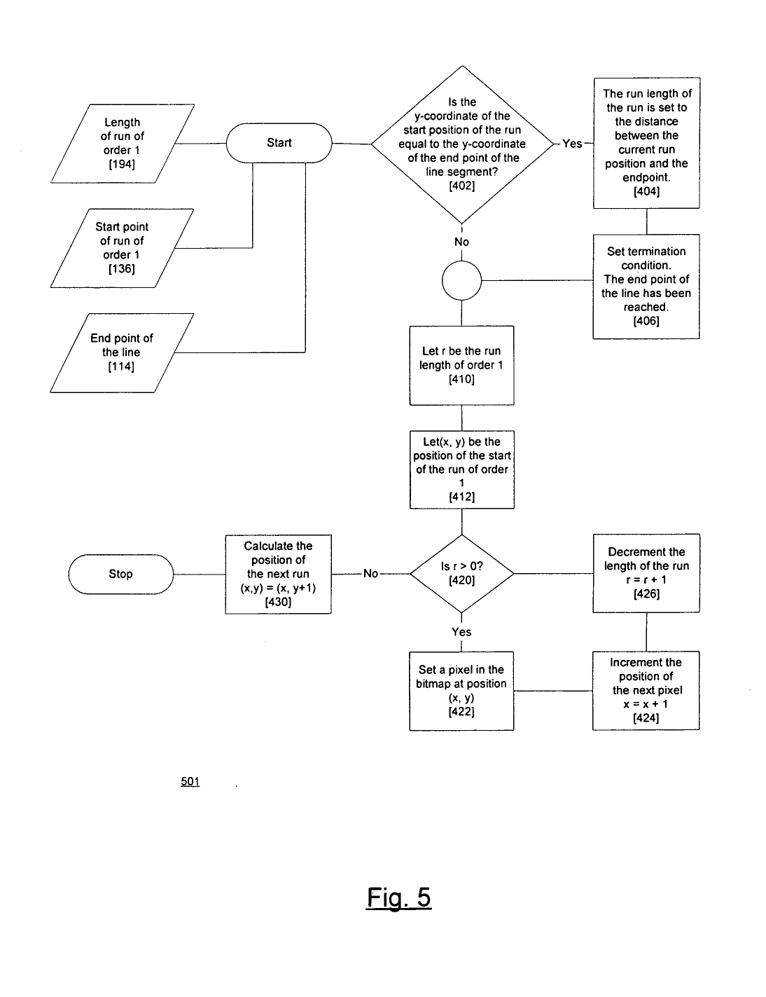

Setting the Pixels of a Run of Order 1 into the Bitmap Memory: FIG. 5

FIG. 5 is a flowchart 501 showing how to set the pixels of a run of order 1 [340]. The method requires as inputs the starting pixel [136], (xⱼ^{[l]},yⱼ^{[l]}), the end point of the line [114], and the length of the run [194], rⱼ^{[l]}, are required. The starting pixel is stored and updated internally [136]. The length of the run [194] is passed to the Bitmap Processor.

Each pixel in the run has a similar y-coordinate, which is the y-coordinate of the starting pixel [136], yⱼ^{[l]}.

If the y-coordinate for the run being set is the same as the floor of the y-coordinate of the end point of the line, yⱼ^{[1]}=└y₁┘, the run being set is the last run in the line [402]. In this case:
The termination condition [160] signaling that the end point of the line has been reached is set [406].
The length of the run to be set [194] is changed to the difference between the x-coordinate of the start of the run being set and the ceiling of the x-coordinate of the endpoint of the line, rⱼ^{[l]}]=┌x₁┐−xⱼ^{[l]} [404].
The run of pixels of length rⱼ^{[l]}=┌x₁┐−xⱼ^{[l]} is set in the Bitmap Memory at location (xⱼ^{[l]}, yⱼ^{[l]}).

To set each of the pixels in the run into the Bitmap Memory, for each of the pixels in the run [410][420][4261 starting at the pixel (xₖ^{[0]}, yₖ^{[0]})=(x₁^{[1]}, yⱼ^{[1]}) [412]:
Set the pixel (xₖ^{[0]}, yₖ^{[0]}) into the Bitmap Memory [422].
Move to the position of the next pixel, (xₖ₊₁^{[0]}, yₖ₊₁^{[0]})=(xₖ^{[0]}+1, yₖ^{[0]}) [424].

Once every pixel in the run has been set into the Bitmap Memory, the starting coordinate of the next run of order 1 in the line is calculated from the current coordinate value by incrementing the current y-coordinate of the next pixel position [430], (xⱼ₊₁^{[1]}, yⱼ₊₁^{[l]})=(xₖ^{[0]}, yₖ^{[0]}+1).

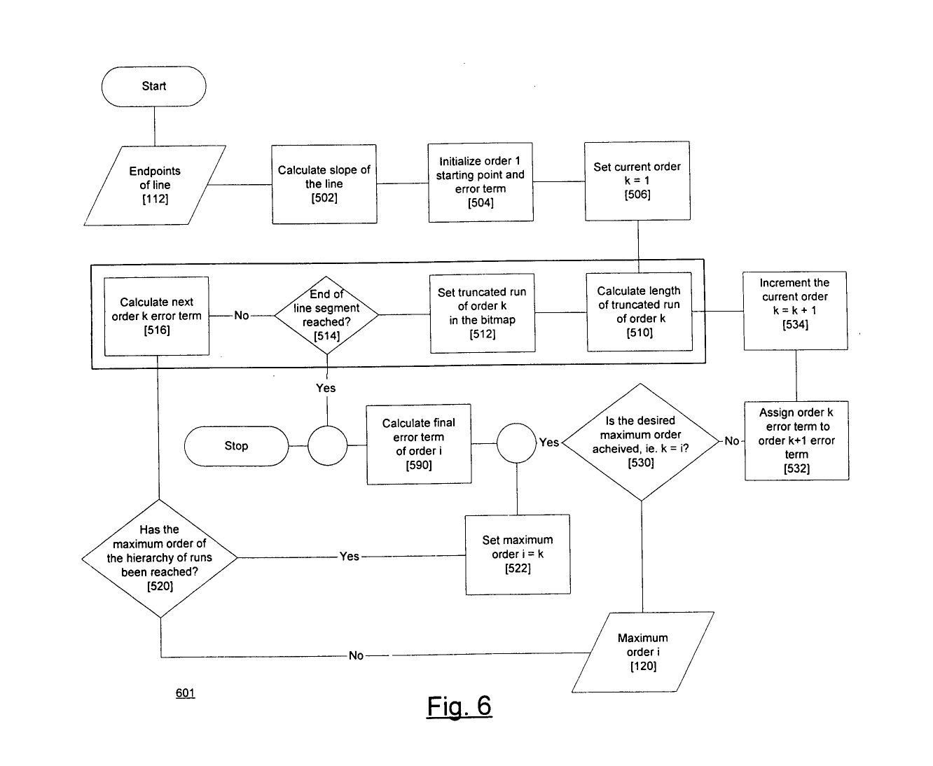

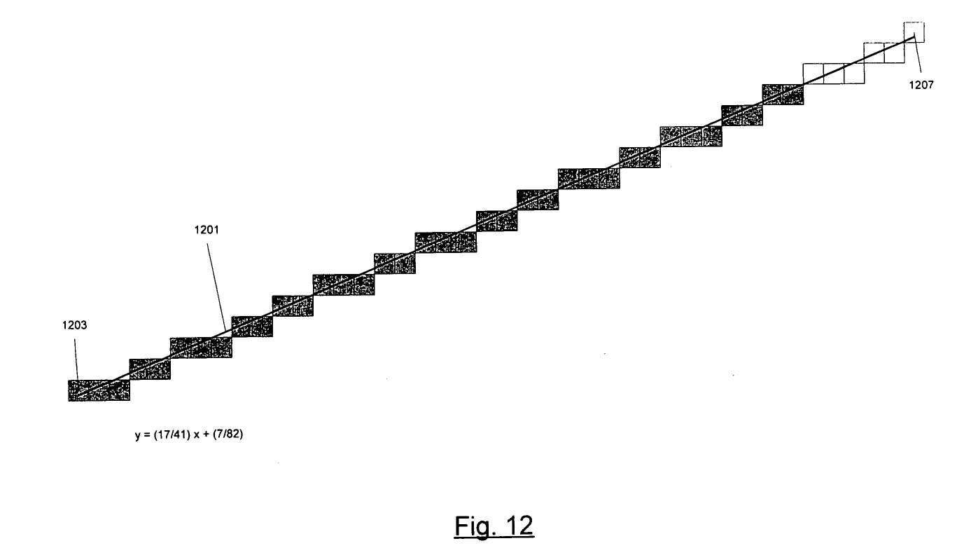

How the First Truncated Run of Order i in the Line Segment is Processed by the Truncated Run Processor: FIGS. 6 and 12

To calculate the length of the initial truncated run length of the maximum order i [120] we calculate and set in the Bitmap Memory each initial truncated run length of order 1 to i in turn. This is shown in flowchart 601 of FIG. 6. If no truncated run length exists for any order, none is set. The process stops if:
The endpoint of the line [110] is reached [514].
The maximum depth of the hierarchy is reached [520].
The desired maximum order is reached [530].

A truncated run length of order k is of course made up of run lengths of orders 0 through k−1. In the above technique, the orders 1 through k are processed beginning with order i=1 and moving order by order to i=k. With each of the orders, the bits for that order are set before the next higher order is processed. For a given order i, the bits set for order i−1 will always make up the complete truncated or untruncated first run of the order i.

Initialize the Slope of the Line [502].

The endpoints of the line segment are the real number coordinates (x₀, y₀) and (x₁, y₁) [112], such that x₀≦x₁ and y₀≦y₁, therefore the slope of the line, α, has a value between zero and one, 0≦α<1.

The slope of the line is calculated by α=(y₁−y₀)/(x₁−x₀) [502]. In example line 1201 of FIG. 12, the equation of the line is y=17×/41+7/82, therefore α=17/41. Example line 1201's endpoint (x₀, y₀) 1203 is (1/2,12/41); its endpoint (x₁, y₁) 1207 is (41+1/2,17+12/41). Note that while the coordinates of the endpoints are rational numbers in this case, a coordinate may be any real number.

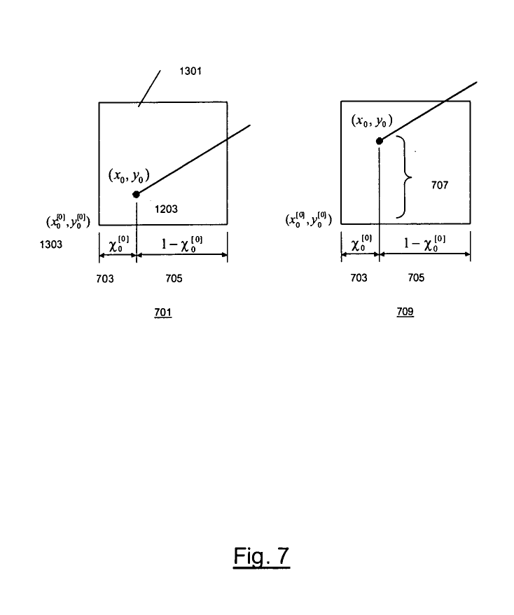

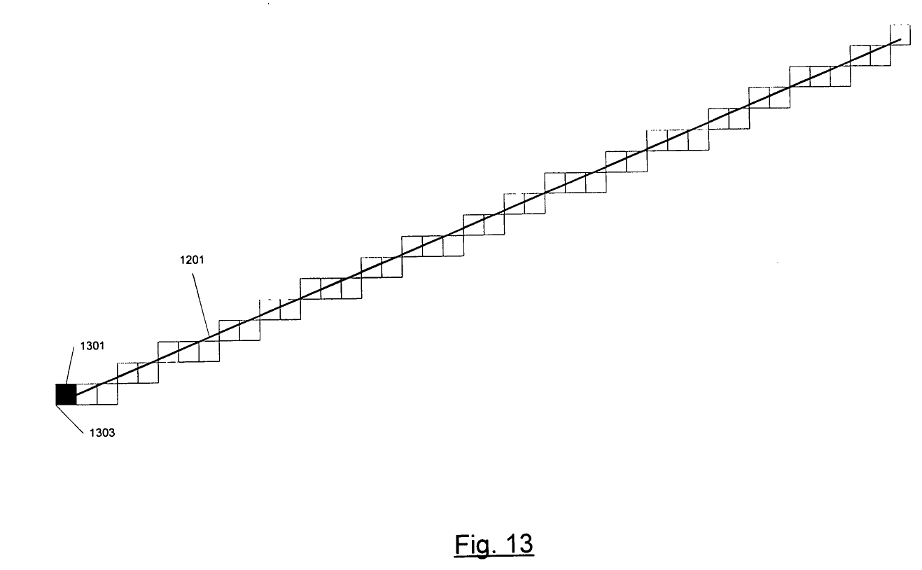

Initialize Order 1 Starting Pixel and Error Term [504]: FIGS. 7 and 13

The first step in the algorithm is to handle the pixel in which the start point of line lies as described in FIG. 13. At the completion of this step, the dark pixel 1301 at the start of the line will have been processed.

As may be seen from FIG. 13, the coordinates of the lower left-hand corner 1303 of pixel 1301 that contains the start point 1203 of line 1201 is:
x₀^{[0]}=└1/2┘=0
y₀^{[0]}=└12/41┘=0

To decide whether to set the first pixel in the line separately from the first run we define the distance X₀^{[0]} 703 from the start point of the line to the beginning of the pixel as described in FIG. 7:
X₀^{[0]}=x₀−x₀^{[0]}
   or 1/2 in our example. If X₀^{[0]}≈0, the first pixel must be set separately from the first run.

We also require the initial value error term \hat{β}₀^{[0]} of order zero normalized against the slope of the line. Given the average run length in the line τ^{[1]}=41/17 in example line 1201,
\hat{β}₀^{[0]}=(y₀−y₀^{[0]})τ^{[1]}=12/17 where y₀−y₀^{[0]} is the distance from the y coordinate of starting point 203 to the y coordinate of the lower left-hand corner 1303 of pixel 1301 and

$${τ}^{[ 1 ]} = \frac{1}{{α}^{1}} .$$

Since X₀^{[0]} is nonzero, the Bitmap Processor sets a run of order 0 (a pixel) into the bitmap memory at the location (x₀^{[0]}, y₀^{[0]})=(0,0). There are two choices for the position of the next pixel in the line segment (1,0) or (1,1). The choice from these two is made using the value of the error term \hat{β}₀^{[0]}. There are two choices for the position of the next pixel in the line segment (x₀^{[0]}+1, y₀^{[0]}) and (x₀^{[0]}+1, y₀^{[0]}+1). The choice from these two is made by the value of the error term \hat{β}₀^{[0]}. Firstly increment the x coordinate and calculate the next error term of order 0:
x₀^{[0]}=x₀^{[0]}=1
\hat{β}₀^{[0]}=\hat{β}₀^{[0]}+1−X₀^{[0]}

In the example of FIG. 7, this comes out to 12/17+1−1/2=41/34, which is less than τ¹, which equals 41/17.

If the error term is less than the average run length of order 1 as shown at 701 in FIG. 7, the next pixel is pixel (x₀^{[0]}+1, y₀^{[0]})
if \hat{β}₀^{[0]}<τ^{[1]} then
   y₀^{[1]}=y₀^{[0]}

If the error term is greater than or equal to the average run length of order 1 as shown at 709 in FIG. 7, the next pixel is pixel (x₀^{[0]}+1, y₀^{[0]}+1). Accordingly the error term is also updated.
if \hat{β}₀^{[0]}≧τ^{[1]} then
   y₀^{[0]}=y₀^{[0]}+1
   \hat{β}₀^{[0]}=\hat{β}₀^{[0]}−τ^{[1]}

If X₀^{[0]} is zero, the values of position of the pixel and the error term are not altered and no pixel is set into the memory.

The position of the next run of order 1 in the line segment and the first error term of order 1 is now the position of the next order 0 run and error term of order 0.
x₀^{[1]}=x₀^{[0]}
y₀^{[1]}=y₀^{[0]}

The coordinate (x₀^{[1]}, y₀^{[1]}) is stored as the position of the next run in the line segment [130].

The error term \hat{β}₀^{[0]} is stored [152] as the error term for the next run [150].

Setting the First Truncated Run of Order i>0

Once the first order has been initialized [504][506], the first truncated run of order 1 through i is set, where i is either the desired maximum order [122] or the maximum order in the hierarchy of runs in the line [124].

The process for setting the first truncated run of order k=1 is as follows. Starting at order k=1 [506]:
1. Calculate the length of the first truncated run of order k [510], r₀^{[k]}.
2. Set the truncated run of order k into the Bitmap Memory [512] if the run is truncated.
3. Check that the end point of the line has not been reached [514]. If it has, cease processing and if it has not continue.
4. Calculate the next error term of order k [516].
5. Check if k is the maximum depth of the hierarchy of runs in the line [520]. If so, set the maximum order of runs [120] to be the maximum order of the hierarchy of runs [124], update and store [152] the final value of the error term [150] [590] and cease processing. If not continue.
6. Check if k is the desired maximum order of runs for the line [530]. If so, update and store [152] the final value of the error term [150] [590] and cease processing. If not continue.
7. The current error term of order k is the next error term for order k+1 [532].
8. Move to the next order [534], k=k+1.
   Structure of the Hierarchy of Runs

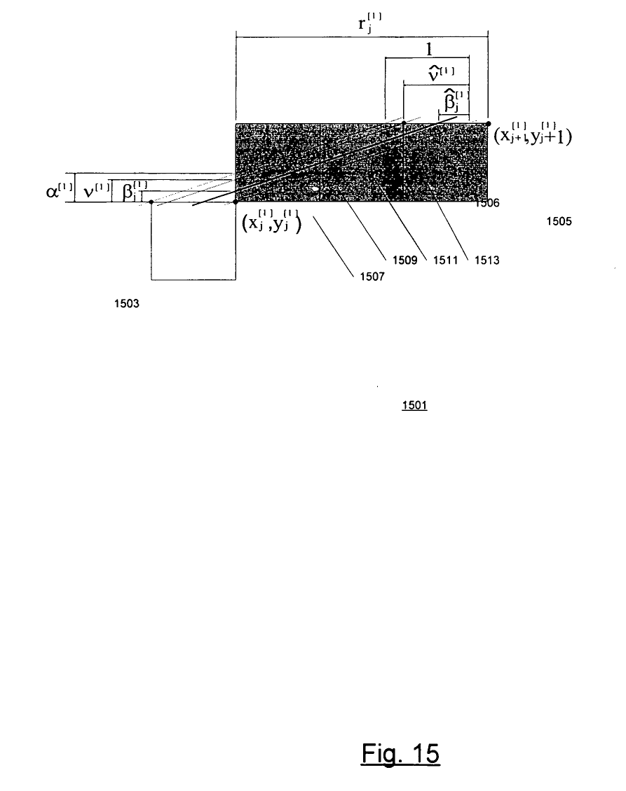

During this process the structure of the hierarchy of runs will be calculated and stored [140]. The structure of the hierarchy of runs stores a description of each level in the hierarchy from order 1 to the defined maximum order [120]. Each record of the description for order i stores the following entries:
The slope of the line of order i, α^{[k]}.
   The slope of the line of order 1 is defined to be the slope of the line, α^{[1]}=α.
   The slope of the line of order k>1, α^{[k]}=min(\hat{μ}^{[k-1]},\hat{v}^{[k-1]}).
The average length of a run of order i in the line, τ^{[k]}=/α^{[k]}.
The length of a short run of order i, rₗ^{[k]}=|τ^{[k]}|.
The length of a long run of order i, r₁^{[k]}=|τ^{[k]}|.
The type of the runs of order i in the line, t^{[k]}, either 0 or 1.
   The type of order 1 is defined to be t^{[1]}=0.
   The type of order k>1 is defined to be t^{[k]}=0 if \hat{μ}^{[k-1]}≦\hat{v}^{[k-1]}.
   The type of order k>1 is defined to be t^{[k]}=1 if \hat{μ}^{[k-1]}>\hat{v}^{[k-1]}.
The structural parameters \hat{μ}^{[i]} and \hat{v}^{[i]}.
   If the type of order k, t^{[k]}=0, then the structural parameters of order k,
      \hat{v}^{[k]}=τ^{[k]}−rₛ^{[k]}, and
      \hat{μ}^{[k]}=1−\hat{v}^{[k]}
   If the type of order k, t^{[k]}=1, then the structural parameters of order k,
      \hat{μ}^{[k]}=96 ^{[k]}−rₛ^{[k]}, and
      \hat{v}^{[k]}=1−\hat{μ}^{[k]}
         Geometry of the Error Parameter \hat{β}ⱼ^{[1]} and the Structural Parameters \hat{v}^{[1]} and \hat{μ}^{[1]}: FIG. 15

As may be seen from the foregoing, the error parameter is used to calculate lengths of runs and the structural parameters \hat{v}^{[i]} and \hat{μ}^{[i]} are used to determine the type of an order. FIG. 15 shows geometrically why the error parameter and the structural parameters can be used in this fashion. The figure shows a first-order run j of pixels 1505 representing a portion of line 1507 with slope α. In first-order runs, the slope at α^{[1]} of the run is the same as the slope of the line 1507. Shown at 1503 is the last pixel of the run j−1. The coordinates (xⱼ^{[1]}, yⱼ^{[1]}) are the coordinates of the lower left-hand corner of the first pixel of run j; the coordinates (xⱼ₊₁^{[1]}, yⱼ₊₁^{[1]}) are the coordinates of the lower left-hand corner of the first pixel of the first pixel of run j+1. The values of the error parameter and the structural parameters are defined geometrically by means of lines that are parallel to line 1507 and intersect corners of the pixels of run j. Thus, line 1509 intersects the upper left-hand corner of pixel 1503; line 1511 intersects the upper left-hand corner of the last pixel 1506 in run j; line 1513 intersects the bottom left-hand corner of the first pixel in run j.

The error parameter \hat{β}ⱼ^{[1]} is the distance on the line formed by the top of pixel 1506 between the intersections of lines 1507 and 1513 with that line. The greater the distance between lines 1507 and 1513, the shorter the next run must be. Moreover, since a line is drawn beginning with a partial run of the maximum order k and the partial run is made by beginning with a partial run of order 1, followed by a partial run of order 2, and continuing through order k, the error term for the partial run of order i is that resulting from order i−1.

The structural parameter \hat{v}^{[1]} is the distance on the line formed by the top of pixel 1506 between the intersection of line 1513 with the line formed by the top of pixel 1506 and the upper left-hand corner of pixel 1506. The type of order 1 is defined to be 1, so the structural parameter \hat{μ}^{[1]}=1−\hat{v}^{[1]}. The structural parameters vary with the slope α^{[i] of the line as represented by runs of order i, and thus can be used to determine the type of order i+}1.

Calculation of the Length of the Truncated Run

To calculate the length of the first truncated run of order k [510], r₀^{[k]}, first check if the run is truncated. If the run is not truncated, the length of the first run is assumed to be zero, r₀^{[k]}=0, and no run is set into the Bitmap Memory [512]. The first run of order k in the line is truncated if the stored error term [150], \hat{β}₀^{[k-1]}>1.

If the run of order k is truncated, the length of the run is:
r₀^{[k]}=|τ^{[k]}−\hat{β}₀^{[k-1]}| if type t^{[k]}=0.
r₀^{[k]}=|\hat{β}₀^{[k-1]}| if the type t_{[k]}=1.

If the run is not truncated, the error term for the next order is the same as this order \hat{β}₀^{[k]}=\hat{β}₀^{[k-1]}.

The run of order k and length r₀^{[k]} can now be set into the Bitmap memory.

If the run is truncated the initial truncated run length and initial decision value of order k is:
\hat{β}₀^{[k]}=r₀^{[k]}−τ^{[k]}+\hat{β}^{k-1]} if the type t^{[k]}=0.
\hat{β}₀^{[k]}=\hat{β}₀^{[k-1]}−r₀^{[k]} if the type t^{[k]}=1.

At the end of the process of setting the initial truncated runs, we have drawn the first truncated run of order i in the line segment. We have the position of the next run of order i in the line if it exists, (x₁^{[i]}, y₁^{[i]}) and the decision value \hat{β}₁^{[i]}. We therefore move to the next phase of the process which calculates the length of the next run of order i in the line, which is then set into the memory. The length of the next run of order i is decided from the two possible by the value of the decision variable, \hat{β}₁^{[i]}.

To update [590] the value of the error term of order i, \hat{β}₁^{[i]}, the value of \hat{β}₁^{[i]} is adjusted by −\hat{v}^{[i]}, \hat{β}^{[i]}=\hat{β}₁^{[i]}−\hat{v}[i] and this value is stored [152] for use by the Run Processor [104].

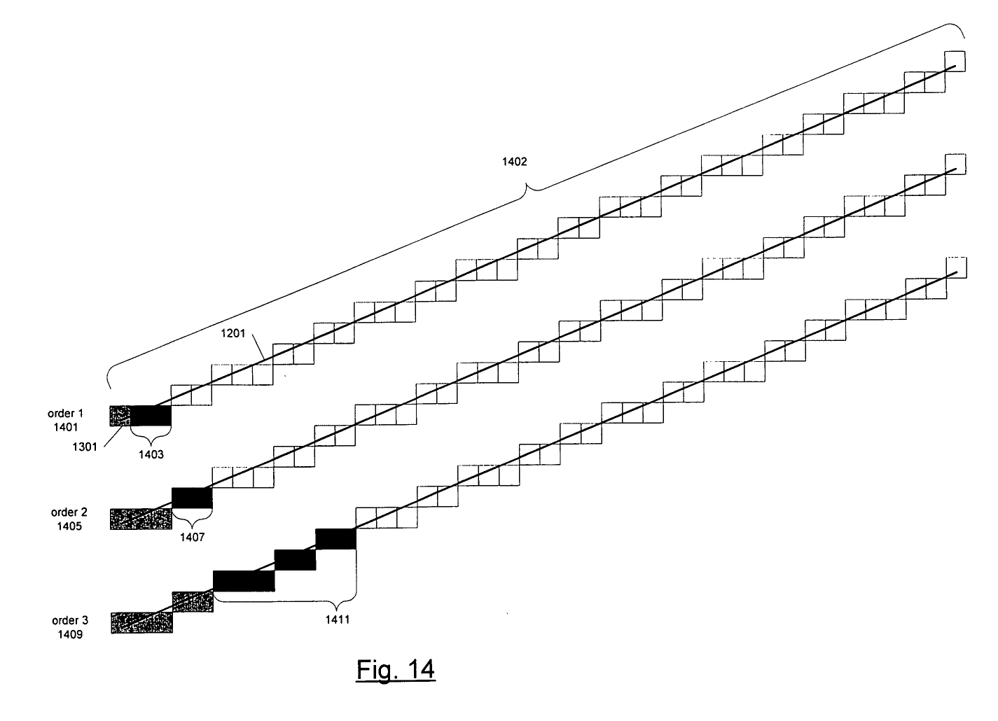

An Example of Setting Orders 1-3: FIG. 14

FIG. 14 shows line 1201 and the pixels 1402 that will be generated to represent it according to the technique under discussion. At 1401 is shown how the first truncated run 1403 of order 1 is set; at 1405 is shown how the first truncated run 1405 of order 2 is set; and at 1407 how the first truncated run of order 3 is set.

Once the first order has been initialized [504][506], the first truncated run of order 1 through i is set, where i is either the desired maximum order [122] or the maximum order in the hierarchy of runs in the line [124]. For the sake of the example, we will take the desired order to be i=3. As part of the initialization, first pixel 1301 has been set and the position of the next pixel relative to first pixel 1301 has been determined as described above.

Order 1

The next step is to handle the first truncated run of order 1 if it exists. In the example line, the portion on the line that will be processed is described by the dark pixels 1403.

The definition of the hierarchy of runs at order 1 in [146] is:
The slope of the line of order 1, α^{[i]}=17/41.
The average length of a run of order 1 in the line, τ^{[1]}=41/17.
The length of a short run of order 1, rₛ^{[1]}=└τ^{[1]}┘]=2.
The length of a long run of order 1, r₁^{[1]}=|τ^{[1]}|=3.
The type of the runs of order 1 in the line is defined to be, t^{[1]}=0.
The structural parameters \hat{μ}^{[1]} and \hat{v}^{[1]}.
   \hat{v}^{[1]}=τ^{[1]}−rₛ^{[1]}=7/17, and
\hat{μ}^{[1]}=1−\hat{v}^{[1]}=10/17.

The length of the first truncated run of order 1 [510], r₀^{[1]}, is truncated since the stored error term [150], \hat{β}₀^{[0]}=41/34>1. The length of the truncated run is r₀^{[1]}=τ^{[1]}−\hat{β}₀^{[0]}|=┌41/17−41/34┐=2 since the type t^{[1]}=0. The run of order 1 and length r₀^{[1]}=2 can now be set into the Bitmap memory at position (x₀^{[0]}, y₀^{[0]})=(1,0). The initial decision value of order 1 is \hat{β}₀^{[1]}=r₀^{[1]}−τ^{[1]}+\hat{β}₀^{[0]}=2−41/17+41/34=27/34.

Order 2

The initial truncated run of order 2 1405 is described by the dark pixels 1407 in line 1201. The initial truncated run of order 2 has a length of one (i.e. one run of order 1). The position of the initial truncated run of order 2 is (x₀^{[2]}, y₀^{[2]})=(x₀^{[1]}+r₀^{[1]}+1)=(3,1).

The hierarchy of runs at order 2 is described by the parameters:
The slope of order 2, α^{[2]}=min(\hat{μ}^{[1]},\hat{v}^{[1]})=7/17.
The average length of a run of order 2 in the line, τ^{[2]}=17/7.
The length of a short run of order 2, rₛ^{[2]}=2.
The length of a long run of order 2, r₁^{[2]}=3.
As \hat{μ}^{[1]}>\hat{v}^{[1]}:
   t^{[2]}=1
   \hat{μ}^{[2]}=τ^{[2]}−rₛ^{[}^{2]}=3/7
   \hat{v}^{[}^{2]}=1−\hat{μ}^{[2]}=4/7

The first run of order 2 in the line is truncated because the stored error term [150] renormalized to the slope of order 2, \hat{β}₀^{[1]}=\hat{β}₀^{[1]}τ^{[2]}=27/14, is greater than 1. Therefore as t^{[2]}=1:
r₀^{[2]}=|\hat{β}₀^{[1]}|=1
\hat{β}₀^{[2]}=\hat{β}₀^{[1]}−r₀^{[2]}=13/14

As the shape of the runs of order 2 is shape ls⁺, the last run of order 1 in a run of order 2 is a short run of order 1. A short run of order 1 has a length of two pixels. Therefore two pixels are set in this stage.

Order 3

The initial truncated run of order 3 1409 is described by the dark pixels 1411. The initial truncated run of order 3 has a length of one (i.e. one run of order 2). The runs of order 3 in the line have a shape s⁺l, the last run of order 2 in a run of order 3 is a long run. Therefore we will set a run of order 2 of length three.

The hierarchy of runs at order 3 is described by the parameters:
The slope of order 3, α^{[3]}=min(\hat{μ}^{[2]},\hat{v}^{[2]})=3/7.
The average length of a run of order 3 in the line, τ^{[3]}=7/3.
The length of a short run of order 3, r₁^{[3]}=2.
The length of a long run of order 3, r₁^{[}^{3]}=3.
As \hat{μ}^{[2]<\hat{v}}^{[2]}:
   t^{[3]}=0
   \hat{v}^{[3]}=τ^{[3]}−rₛ^{[3]}=1/3
   \hat{μ}^{[3]}=1−\hat{v}^{[3]}=2/3

The first run of order 2 in the line is truncated because the stored error term [150] renormalized to the slope of order 3, \hat{β}₀^{[2]}=\hat{β}₀^{[2]}τ^{[3]}=13/6, is greater than 1. Therefore as t^{[2]}=0:
r₀^{[3]}=|τ^{[3]}−\hat{β}₀^{[2]}|=┌1/6┌=1
\hat{β}₀^{[3]}=r₀^{[3]}−τ^{[3]}+\hat{β}₀^{[2]}=5/6

Therefore a single run of order 2 comprises the run of order 3. Now that the order chosen for the iterative portion of the technique has been reached, the normalized intercept value of order 3, \hat{β}₀^{[3]}=5/6, can be used to initialize the iterative decision process.

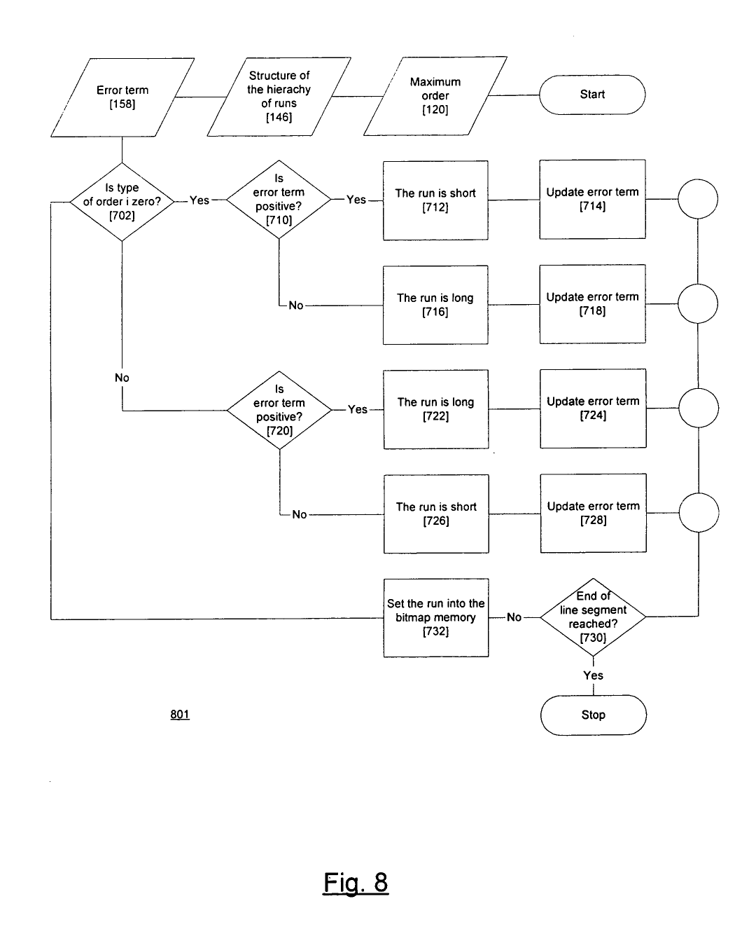

Setting Full-length Runs of Order i in the Line: FIG. 8

To set a full length run of order i into the Bitmap Memory [108], the Run Processor [104] performs the steps shown in flowchart 801. The inputs are the maximum order of the runs (120), the structure of the hierarchy of runs [146] which was determined by truncated run processor [102] while processing the truncated runs, and the error term \hat{β}ⱼ^{[i]} provided by truncated run processor [102]. For each run of order i, the run processor determines the length of the run of order i in the line and passes the run's length and order to the Bitmap Processor [106] to set the actual pixels of the run into the Bitmap Memory [732]. The calculation of the length of the run of order i is based on the type of order (i) [702] and the value of the error term [150], \hat{β}ⱼ^{[i]}, retrieved [158] by the Run Processor [710,720]. Once the length of the run has been calculated, the error term is updated, \hat{β}ⱼ₊₁^{[i]}, and stored [156]. The flow chart branches involved here are [702, 710, 712, 714]; [702, 710, 716, 718]; [702, 720, 722, 724]; and [702, 720, 726, 728].

The calculation of the length of the run of order i in the line, rⱼ^{[i]} is as follows:
If type t^{[i]}=0:
   If \hat{β}ⱼ^{[i]}≧0 [710] the run is short [712], rⱼ^{[i]}=rₛ^{[i]}, and \hat{β}ⱼ₊₁^{[i]}=\hat{β}ⱼ^{[i]}−\hat{v}^{[i]} [714].
   If \hat{β}ⱼ^{[i]}<0 [710] the run is long [716], rⱼ^{[i]}=r₁^{[i]}, and \hat{β}ⱼ₊₁^{[i]}=\hat{β}ⱼ^{[i]}+\hat{μ}^{[i]} [718].
If type t^{[i]}=1:
   If \hat{β}ⱼ^{[i]}≧0 [720] the run is long [722], rⱼ^{[i]}=r₁^{[i]}, and \hat{β}ⱼ₊₁^{[i]}=\hat{β}ⱼ^{[i]}−\hat{v}^{[i]} [724].
   If \hat{β}ⱼ^{[i]}<0 [720] the run is short [726], rⱼ^{[i]}=rₛ^{[i]}, and \hat{β}ⱼ₊₁^{[i]}=\hat{β}ⱼ^{[i]}+\hat{μ}^{[i]} [728].

The values of the structural parameters \hat{μ}^{[i]} and \hat{v}^{[i]} and the length of a short and long run, r₂^{[i]} and r₁^{[i]}, are retrieved [144] from the structure of the hierarchy of runs [140].

Once the length of the run is calculated, the run is set into memory [194] by the Bitmap Processor [106] and [732]. The Run Processor keeps processing runs as just described until it reaches the end of the line segment [730].

Applications of the Line Drawing Techniques

The line drawing techniques described herein can be employed in any application where techniques of the general class to which these techniques belong are useful. The techniques are of course particularly useful in applications where the coordinates of the endpoints of the lines may have real number values, including values that are irrational numbers. Such applications include the following:

Two-Dimensional Polygon Filling and Scan Conversion

Techniques for filling a polygon on a raster or bitmap display often step along the circumference of the polygon and fill or scan convert the polygon along the horizontal runs defining the interior of the polygon (see Lathrop 1990). A problem with using existing line drawing techniques for this purpose is that the endpoints of the line are defined at pixel or sub-pixels positions and using these algorithms to step along the circumference of the polygon can cause dropouts or multiply processed pixels to occur. The line drawing technique described can be used to step along the circumference of the polygon without these errors.

Three-Dimensional Polygon Scan Conversion

When a 3D polygon is being rendered into a 2D image using interpolative techniques such as Gouraud or Phong shading, typically a technique similar to the 2D polygon scan conversion embodiment is used. A technique that is also possible is to shade the polygon using lines of constant depth. Think of a plane parallel to the view plane being used. As the plane is moved backwards through the polygon, the line of intersection between the plane and the polygon can be defined. This line has a constant depth that can be used to make the shading technique more efficient. To shade the polygon you can step along this line using the line drawing technique described setting each pixel the color calculated by the shading algorithm.

Visibility Checking—Computer Games and Simulation

In computer games and simulation a common problem is to determine if two points are visible to one another. If the environment that can occlude the two points can be defined on a 2D grid, the line drawing technique describe can be used to check each of the grid points linearly separating the two points to determine if they are occluded from one another.

Visibility Checking—Mobile Network Planning

In the mobile phone industry one of the greatest problems is in planning the mobile phone base station network to ensure effective coverage. Mistakes in deciding where to place base stations and their power requirements can be very expensive. One common solution is to use two-dimensional ray tracing methods to simulate the working environment of a mobile network. Effectively the environment is modeled in two dimensions and rays are traced through the environment to determine the coverage achieved. If the space around the environment is modeled as a grid, the process for drawing a line can be used to traverse a ray through the grid. The line segment becomes a ray if no endpoint is assumed. As the line is traced through the environment, instead of drawing each pixel in the display bitmap, the grid cell can be checked.

Simulation of Sonar Propagation

In sonar propagation simulation, often laminar sheets of water or other media are traced with rays to determine the propagation of rays through the medium. If the media can be modeled on a discrete grid, the line drawing algorithm can be used to propagate the ray through the medium.

Height Field Rendering

Ray tracing has long been used to render height fields or elevation maps. The run-based ray line drawing technique can be adapted to traverse a ray over the height field to seek an intersection with an elevation.

Hough Transform

In line and shape detection problems in which the Hough Transform is used as a voting strategy, the voting process requires a line of votes to be cast into an array. The run-based line digitization techniques described can be used to cast the votes.

Additional Line Drawing Techniques that Use the Line Structure Information

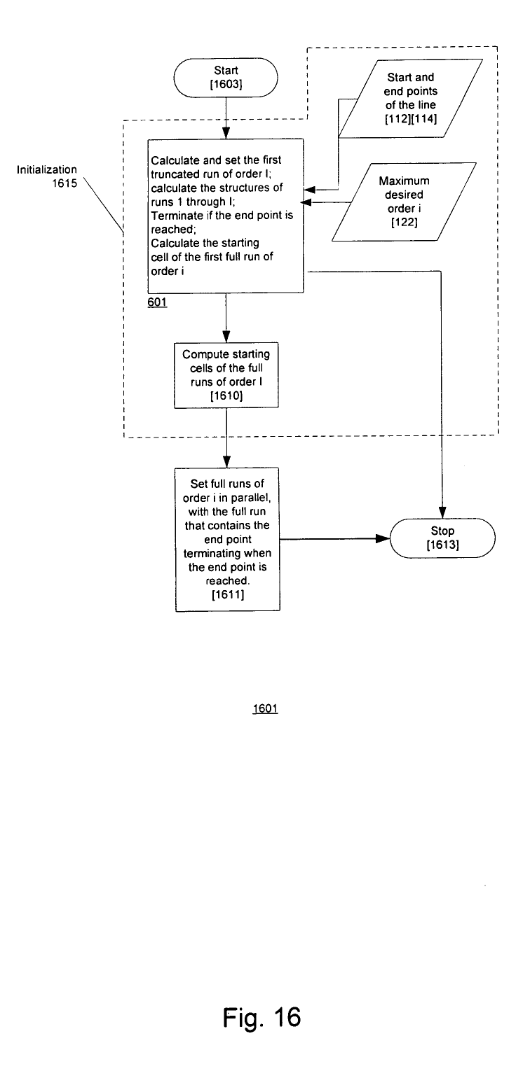

The line drawing techniques that are the subject matter of PCT/US02/24711, the parent of this patent application, require that information about the structure of the line being drawn be computed. The structural information can also be used to enhance other aspects of drawing a line. Three of these are discussed in the following:
techniques for drawing lines or computing rays in parallel;
techniques for adding anti-aliasing pixels to lines drawn using runs of pixels; and
techniques for improving memory setting processes based on runs.
   Parallel Techniques for Determining the Cells of a Raster that are Intercepted by a Line: FIG. 16

An advantage of using runs of any order n to determine the cells of a raster that are intercepted by a line is that once the first truncated run of order n is drawn and the structural information about the line has been computed, it can be used to determine the positions in the raster of all of the other runs of order n of cells that are intercepted by the line. Consequently, if the hardware or software being used to determine the cells permits it, the cells belonging to the other runs of order n can be computed in parallel. The parallel computations can be performed by calculating each run of order n in the cells intersected by the line in parallel; or by calculating the positions of groups of runs of order n in the cells intersected by the line in parallel and using the sequential version of the algorithm to draw each group. Another level of parallelism could be attained within each run by setting multiple runs of a lower order or pixels per iteration of the sequential or parallel version of the algorithm. The run of order n could be divided into runs of an order less than n, each of which could be processed in parallel.

FIG. 16 gives an overview of how runs may be computed in parallel. There are two parts: initialization 1615, which calculates and sets the first truncated run of cells and then computes the starting cells of each of the full runs of order i being set, and the part 1615 that sets the full runs in parallel. Beginning with start 1603, the first part of the initialization is done as shown in FIG. 6. As set forth in the explanation of FIG. 6, truncated run processor 102 receives as inputs the endpoints of the line; from the endpoints, it calculates the line's slope and determines the starting pixel and the starting point and error term β for the first run truncated run of order 1. Then it proceeds as follows for that order and all others 1 . . . n: first it calculates the length of the truncated run of the order, then it sets the truncated run in the bitmap, and then it calculates the error term for the next order. At the end of the process, the location of the starting pixel of the first full run of order n is known, along with the error term. From this information, the starting cells and structure parameters of each of the full runs of order n may be computed, as shown at 1610. This completes the initialization, and the full runs are set in parallel, with the last run terminating when the line's end point is reached.

The apparatus of FIG. 2 may be modified to perform the processing of FIG. 16 by replacing bitmap processor [106] with a number of bitmap processors 106(a . . . j), which can operate on bitmap memory 108 in parallel. Run processor 104 would then give each bitmap processor 106(i) the starting cell and structure parameters for the run that bitmap processor 106(i) is to set. The degree of order n may be determined by the number of bitmap processors 106; for example, if there are four bitmap processors, the degree of order n may be that at which the line contains full runs and a final truncated or untruncated run such that the total number of the full and final runs is divisible by 4. The degree of order n may be determined by the designer or based on external parameters such as the length and slope of the line. The bitmap processors may also be able to set an array of bits in a single operation; in that case, the order whose runs best fit the array that the bitmap processor can set might be the one for which the operation is parallelized.

|Computing the Starting Points of the Runs for Order 1|

To calculate the position of the j-th full length run in the line, let us reconsider the linear equation given by
βⱼ^{[1]}−β₀^{[1]}=α^{[1]}(xⱼ^{[1]}−x₀^{[1]})−(yⱼ^{[1]}−y₀^{[1]})
where \hat{β}₀^{[1]} is the intercept value of the first full length run given at position (x₀^{[1]}, y₀^{[1]}). We know that j=yⱼ^{[1]}−y₀^{[1]} as the height of a run is always one.

Therefore the position of the j-th full length run in the line is
(xⱼ^{[1]},yⱼ^{[1]})=([βⱼ^{[1]}−β₀^{[1]}+j+x₀^{[1]}]/α^{[1]},y₀^{[1]}+j)

To increase the efficiency of the algorithm, we can normalize each of the values at order 1 by α^{[1]}. This eliminates a number of division and multiplication operations.

Computing the Starting Points of the Runs for Order 2

To calculate the position of the j-th run in the line, let us reconsider the linear equation given by
βⱼ^{[1]}−β₀^{[1]}=α^{[1]}(xⱼ^{[1]}−x₀^{[1]})−(yⱼ^{[1]}−y₀^{[1]})
For order 2 we have
βⱼ^{[2]}−β₀^{[2]}=α^{[1](}xⱼ^{[2]}−x₀^{[2]})−α^{[0]}(yⱼ^{[2]}−y₀^{[2]}).

Define pⱼ^{[h]}, where h≦i, to be the number of runs of order h in the partial line up to the beginning of the j-th run of order i from the first full-length run of order 2. Therefore
pⱼ^{[0]}=xⱼ^{[2]}−x₀^{[2]}
pⱼ^{[1]}=yⱼ^{[2]}−y₀^{[2]}
pⱼ^{[2]}=j
The above linear equation for order 2 becomes
βⱼ^{[2]}=α^{[1]}pⱼ^{[0]}−α^{[0]}pⱼ^{[1]}.
For runs of order 2, shape 0, we have α^{[2]}=\hat{μ}^{[1]}=(r^{[1]}+1)α^{[1]}−α^{[0]} and by substituting for α^{[0]} into the previous equation we have
βⱼ^{[2]}=α^{[2]}pⱼ^{[1]}−α^{[1]}((r^{[1]}+1)pⱼ^{[1]}−pⱼ^{[0]})

For this shape, each run of order 2 must contain a long run of order 1 and r^{[1]}+1 short runs therefore a^{[1]}=(r^{[1]}+1)pⱼ^{[1]}−pⱼ^{[0]}, and
βⱼ^{[2]}=α^{[2]}pⱼ^{[2]}−α^{[2]}pⱼ^{[1]}.
Similarly for shape 1 we get
βⱼ^{[2]}=α^{[1]}pⱼ^{[2]}−α^{[2]p}ⱼ^{[1]}.
Hence for shape 0

$${y}_{j}^{[ 2 ]} = {y}_{0}^{[ 2 ]} + \frac{j {α}^{[ 1 ]} + {β}_{j}^{[ 2 ]} - {β}_{0}^{[ 2 ]}}{{α}^{[ 2 ]}}$$

$${x}_{j}^{[ 2 ]} = {x}_{0}^{[ 2 ]} + \frac{{y}_{j}^{[ 2 ]} + {β}_{j}^{[ 2 ]} - {β}_{0}^{[ 2 ]}}{{α}^{[ 1 ]}}$$

and for shape 1

$${y}_{j}^{[ 2 ]} = {y}_{0}^{[ 2 ]} + \frac{j {α}^{[ 1 ]} - {β}_{j}^{[ 2 ]} + {β}_{0}^{[ 2 ]}}{{α}^{[ 2 ]}}$$

$${x}_{j}^{[ 2 ]} = {x}_{0}^{[ 2 ]} + \frac{{y}_{j}^{[ 2 ]} + {β}_{j}^{[ 2 ]} - {β}_{0}^{[ 2 ]}}{{α}^{[ 1 ]}}$$

To increase the efficiency of the algorithm, we can normalize each of the values at order 2 by α[2], as in order 1. This eliminates a number of division and multiplication operations. In this case we can also define \hat{α}^{[2]}=min(\hat{v}^{[2]},\hat{μ}^{[2]}) to be the proportion of runs of order i to order 1 where τ^{[2]}/=1/\hat{α}^{[2]} is the average run length of order 2.

Computing the Starting Points of the Runs for Order i

To describe a general algorithm for any order i we can expand the definition of the algorithm for order 2. The main differences between the algorithm of order 2 and i, is that runs of any order i>2 occur in one of the four possible shapes not two. For orders beyond 2 however there is no restriction that the first run in the line y=αx is long, therefore all four shapes are possible. Apart from this key difference, the calculation of the structural parameters, the length of the initial truncated run length, the starting point of each run of order i and the length of each run of order i can be derived from order 2.

To expand on our idea of shape at order 2, we define the type instead of the shape of the runs of order i>1 to be type t^{[i]}=0 if μ^{[i-1]}<v^{[i-1]}, type t^{[i]}=1 if v^{[i-1]}<μ^{[i-1]} and define the type of order 1 to be t^{[i]}=0, we can calculate the shape by the relationship
s^{[i]}=t^{[i-1]}⊕t^{[i]}
where the operator ⊕ denotes the binary concatenation of the two types. For example if t^{[2]}=1 and t^{[3]}=0, shape s^{[3]} has the binary value “10”, or decimal 2, and therefore, s^{[3]}=2: sl⁺. We can use these definitions of type and shape for order 2 by assuming that the type of all runs of order 1 will always be type 0.

The method of calculating the position of the j-th run of order i>2 also follows from our discussion of order 2. To calculate the position of the j-th run in the line, let us reconsider the linear equation given by
βⱼ^{[1]}−β₀^{[1]}=α^{[1]}(xⱼ^{[1]}−x₀ⱼ^{[1]})−(yⱼ^{[1]}−y₀ⱼ^{[1]})
or
βⱼ^{[1]}−β₀^{[1]}=α^{[1]}pⱼ^{[0]}−α^{[0]}pⱼ^{[1]}.

By induction, it is possible to show that for order i, type 0
βⱼ^{[i]}−β₀^{[i]}=α^{[i]}pⱼ^{[i-1]}−α^{[i-1]}pⱼ^{[i]}
and for order i, type 1
βⱼ^{[i]}−β₀^{[i]}=α^{[i-1]}pⱼ^{[i-1]}−α^{[i]}pⱼ^{[i-1]}

Therefore, because pⱼ^{[i]}=j, we can substitute back to orders 1 and 0 where pⱼ^{[1]}=yⱼ^{[i]}−y₀^{[i]} and pⱼ^{[0]}=xⱼ^{[i]}−x₀^{[i]} in a similar manner as we performed for order 2.

To increase the efficiency of the algorithm, we can normalize each of the values at order i by α^{[i]}, similarly to what we did for order 2. This eliminates a number of division and multiplication operations. In this case we can also define \hat{α}^{[i]}=min(\hat{v}^{[i]},\hat{μ}^{[i]}) to be the proportion of runs of order i to order 1 where τ^{[i]}=1/\hat{α}^{[i]} is the average run length of order 2.

Implementing the Calculation of the Starting Positions and Compositions of the Full Runs of Order 1

In the following, μ and ν are the structural parameters described in the parent of the present application. For each scanline, j, in the image given the line segment (x₀, y₀) to (x₁, y₁) such that └y₀┘≦j≦┌y₁┐ where x₀, y₀, x₁, y₁ ∈ R and x₀<x₁:
1. If └y₀┘≦j≦┌y₁┐, the scan line intersects the line segment.
2. The starting point for the line is:
   x₀^{[0]}=└x₀┘
   x₀^{[0]}=└y₀┘
3. To handle the first pixel, the distance of the intercept to the position of the first pixel is calculated:
   β′=(y₀−└y₀┘)−(x₀−└x₀┘)α^{[1]}

If β′≧0 then β₀^{[0]}=β′. If β′<0 then β₀^{[0]}=β′α^{[1]} and the position of the first run is reset to
(x₀^{[0]},y₀^{[0]})=(└x₀┘+1,└y₀┘)
4. Calculate the average run length of order 1.

$${τ}^{[ 1 ]} = \frac{{x}_{1} - {x}_{0}}{{y}_{1} - {y}_{0}}$$
5. The length of the initial truncated run is
   r₁^{[1]}=┌τ^{[1]}−\hat{β}₀^{[0]}┐
6. The intercept value at the start of the first full-length run of order 1 is:
   \hat{β}₀^{[1]}=r₁^{[0]}−(τ^{[1]}−\hat{β}₀^{[0]})
7. If the scanline intersects the start point, i.e. if y₀^{[0]}=j, set a run length r₀^{[1]} at pixel (x₀^{[0]}, y₀^{[0]}) and cease.
8. We now have └y₀┘<j≦┌y₁┐. Set the reference point for the line to start of the first full-length run of order 1 in the line
   (x₀^{[1]},y₀^{[1]})=(x₀^{[0]}+r₀^{[1]},y₀^{[0]}+1)
9. The length of a short run is
   rₛ^{[1]}=└τ^{[1]}┘
10. The portion of long runs of order 1 to the total number of run of order 1 in the line is
11. The vertical distance from the reference point to the intercept of the line and the j-th run is
   δ\hat{β}ⱼ^{[1]}=\hat{β}₀^{[1]}+j(1−\hat{v}^{[1]})
12. The normalized intercept value of the line and the j-th run is
   \hat{β}ⱼ^{[1]}=Δ\hat{β}ⱼ^{[1]}−└Δ\hat{β}ⱼ^{[1]}┘
13. The position of the run is
   (xⱼ^{[1]},y^{[1]})=(\hat{β}ⱼ^{[1]}+jτ^{[1]},j)
14. If the scanline intersects the end point of the line segment, i.e. if y₀^{[1]}=y₁, calculate the last truncated run length
   rⱼ^{[1]}=y₀^{[1]}−┌y₁┐
   Set a run of length rⱼ^{[1]} at pixel (xⱼ^{[1]}, yⱼ^{[1]}) and cease.
15. We now have └y₀┘<j<┌y₁┐ and only the intermediate runs remain. The length of the j-th run is
   rⱼ^{[1]}=rₛ^{[1]} if \hat{β}ⱼ^{[1]}≧\hat{v}^{[1]}
   rⱼ^{[1]}=rₛ^{[1]}+1 if \hat{β}ⱼ^{[1]}<\hat{v}^{[1]}

Set a run of length rⱼ^{[1]} at pixel (xⱼ^{[1]}, yⱼ^{[1]})

Implementing the Calculation of the Starting Positions and Compositions of the Full Runs of Order 2

We assume that the steps 1-5 and 7-10 have been executed and we have values for the parameters x₀^{[0]}, y₀^{[0]}, x₀^{[1]}, y₀^{[1]}, r₁^{[1]}, rₛ^{[1]}, \hat{β}₀^{[1]}, \hat{v}^{[1]}, τ^{[1]}. If j=0 and the first possibly truncated run in the line is to be set, we assume that the first possibly truncated run of order 1 has been set.
1. Calculate the shape of the run of order 1.
   If 1−\hat{v}^{[1]}<\hat{v}^{[1]}
      s^{[2]}=0
   else
      s^{[2]}=1
2. Calculate the average run length of order 1.
   If s^{[2]}=0
      τ^{[2]}=1/(1−\hat{v}^{[1]})
   else
      τ^{[2]}=1/\hat{v}^{[1]}
3. The length of the initial truncated run is
   If s^{[2]}=0
      r₁^{[2]}=|τ^{[2]}−\hat{β}₀^{[1]}|
   else
      r₁^{[2]}=└\hat{β}₀^{[1]}|
4. The intercept value at the start of the first full-length run of order 1 is:
   If s^{[2]}=0
      \hat{β}₀^{[2]}=r₁^{[2]}−(τ^{[2]}−\hat{β}₀^{[1]})
   else
      \hat{β}₀^{[2]}=\hat{β}₀^{[1]}−r₁^{[2]}
5. If j=0, set a run of order 1 and length r₀^{[1]} at pixel (x₀^{[0]}, y₀^{[0]}). Then set a run of order 2, length r₀^{[2]} and shape s^{[2]} at pixel (x₀^{[1]}, y₀^{[1]}) and cease.
6. Set the reference point for the line to start of the first full-length run of order 2 in the line:
   If s^{[2]}=0
      (x₀^{[2]},y₀^{[2]})=(x₀^{[1]}+r₀^{[2]}(rₛ^{[1]}+1)−1,y₀^{[1]}+r₀^{[2]})
   else
      (x₀^{[2]},y₀^{[2]})=(x₀^{[1]}+r₀^{[2]}rₛ^{[1]}+1,y₀^{[1]}+r₀^{[2]})
7. The length of a short run is
   rₛ^{[2]}=└τ^{[2]}┘
8. The portion of long runs of order 1 to the total number of run of order 1 in the line is
   If s^{[2]}=0
      \hat{v}^{[2]}=τ^{[2]}−rₛ^{[2]}
   else
      \hat{v}^{[2]}=1−(τ^{[2]}−rₛ^{[2]})
9. The run-based distance from the reference point to the intercept of the line and the j-th run is:
   δ\hat{β}ⱼ^{[2]}=\hat{β}₀^{[2]}+j(1−\hat{v}^{[2]})
10. The normalized intercept value of the line and the j-th run is
   \hat{β}ⱼ^{[2]}=Δ\hat{β}ⱼ^{[2]}−└Δ\hat{β}ⱼ^{[2]}┘
11. The position of the run is
   If s^{[2]}=0
      yⱼ^{[2]}=y₀^{[2]}+jτ^{[2]}+\hat{β}ⱼ^{[2]}−\hat{β}₀^{[2]}
      xⱼ^{[2]}=x₀^{[2]}+yⱼ^{[2]}τ^{[1]}+(\hat{β}ⱼ^{[2]}−\hat{β}₀^{[2]})/τ^{[2]}
   else
      yⱼ^{[2]}=y₀^{[2]}+jτ^{[2]}−\hat{β}ⱼ^{[2]}+\hat{β}₀^{[2]}
      xⱼ^{[2]}=x₀^{[2]}+yⱼ^{[2]}τ^{[1]}−(\hat{β}ⱼ^{[2]}−\hat{β}₀^{[2]})/τ^{[2]}
12. The length of the j-th run is
   rⱼ^{[2]}=rₛ² if \hat{β}ⱼ^{[2]}≧\hat{v}^{[2]}
   rⱼ^{[2]}=rₛ^{[2]}+1 if \hat{β}ⱼ^{[2]}<\hat{v}^{[2]}
13. Set a run of length rⱼ^{[2]} shape s^{[2]}=t^{[2]} at pixel (xⱼ^{[2]}, yⱼ^{[2]})
   Implementing the Calculation of the Starting Positions and Compositions of the Full Runs of Order i

We assume we have values for the parameters x₀^{[k]}, y₀^{[k]}, r₁^{[k]}, rₛ^{[k]}, \hat{β}₀^{[k]}, \hat{v}^{[k]}, τ^{[k]}, where k=0 . . . i−1. If j=0 and the first possibly truncated run of order i in the line is to be set, we assume that the first possibly truncated run of order i−1 has been set.
1. Calculate the shape of the run of order 1.
If 1−\hat{v}^{[i-1]}<\hat{v}^{[i-1]}
   t^{[i]}=0
else
   t^{[i]}=1
2. Calculate the average run length of order 1.
If t^{[1]}=0
   τ^{[i]}=1/(1−\hat{v}^{[i-1]})
else
   τ^{[i]}=1/\hat{v}^{[i-1]}
3. The length of the initial truncated run is
If t^{[i]}=0
   r₁^{[i]}=|τ^{[i]}−\hat{β}₀^{[i-[1]}|
else
   r₁^{[i]}=└\hat{β}₀^{[i-1]}┘
4. The intercept value at the start of the first full-length run of order 1 is:
If t^{[i]}=0
   \hat{β}₀^{[i]}=r₁^{[i]}−(τ^{[i]}−\hat{β}₀^{[i-1]})
else
   \hat{β}₀^{[i]}=\hat{β}₀^{[i-1]}−r₁^{[i]}
5. If j=0, set a run of order i and length r₀^{[i]} at pixel (x₀^{[i-1]}, y₀^{[i-1]}).
6. Set the reference point for the line to start of the first full-length run of order 2 in the line:
   δr^{[k]}=r₀^{[i]}
for k=i−1, . . . ,1
   if t^{[i]}=0
      δr^{[k]}=δr^{[k+1]}(rₛ^{[k]}+1)−1
   else
      δr^{[k]}=δr^{[k]}rₛ^{[k-1]}−1
      y₀^{[i]}=y₀^{[1]}+δr^{[1]}
      x₀^{[i]}=x₀^{[1]}+δr^{[0]}
7. The length of a short run is
   rₛ^{[i]}=└τ^{[i]}┘
8. The portion of long runs of order 1 to the total number of run of order 1 in the line is
If t^{[i]}=0
   \hat{v}^{[i]}=τ^{[i]}−rₛ^{[i]}
else
   \hat{v}^{[i]}=1−(τ^{[i]}−rₛ^{[i]})
9. The run-based distance from the reference point to the intercept of the line and the j-th run is:
   δ\hat{β}ⱼ^{[i]}=\hat{β}₀^{[i]}+j(1−\hat{v}^{[i]})
10. The normalized intercept value of the line and the j-th run is
   \hat{β}ⱼ^{[i]}=Δ\hat{β}ⱼ^{[i]}−└Δ\hat{β}ⱼ^{[i]}┘
11. The position of the run is
   pⱼ^{[i]}=j
for k=i, . . . ,1
   if t^{[i]}=0
      pⱼ^{[k-1]}=τ^{[2]}pⱼ^{[k]}+(βⱼ^{[2]}−β₀^{[2]})
else
   pⱼ^{[k-1]}=τ^{[2]}pⱼ^{[k]}+(βⱼ^{[2]}−β₀^{[2]})
   yⱼ^{[i]}=y₀^{[i]}−pⱼ^{[1]}
   xⱼ^{[i]}=x₀^{[i]}−pⱼ^{[0]}
12. The length of the j-th run is
   rⱼ^{[i]}=rₛ^{[i]} if \hat{β}ⱼ^{[i]}≧\hat{v}^{[i]}
   rⱼ^{[i]}=rₛ^{[i]}+1 if \hat{β}ⱼ^{[i]}<\hat{v}^{[i]}
13. Set a run of length rⱼ^{[i]}, shape s^{[i]} =t^{[i-1]}⊕t^{[i]} at pixel (xⱼ^{[i]}, yⱼ^{[i]}).
   Optimizations

For the parallel algorithm, we can rearrange the calculations to move many of the expensive operations into the initialization phase of the algorithm. For example Algorithm 1 illustrates a possible implementation of an order 1 algorithm.

Algorithm 1 Calculating the Length and Position of the j-th Run of Order 1 in the Digital Line.

Constants pertaining to the line:

$${τ}^{[ 1 ]} = \frac{1}{{α}^{[ 1 ]}}$$

c₀^{[1]}=τ^{[1]}α^{[0]}
c₁^{[1]}=τ^{[1]}β₀^{[1]}
c₂^{[1]}=τ^{[1]}v^{[1]}

Constants pertaining to the j-th run of order 1.

$${c}_{3}^{[ 1 ]} = \frac{j}{{α}^{[ 1 ]}} = {jc}_{0}^{[ 1 ]} {c}_{4}^{[ 1 ]} = \frac{{β}_{0}^{[ 1 ]} + j {μ}^{[ 1 ]}}{{α}^{[ 1 ]}} = {c}_{1}^{[ 1 ]} + {c}_{3}^{[ 1 ]} {μ}^{[ 1 ]}$$

$${c}_{5}^{[ 1 ]} = \frac{{β}_{j}^{[ 1 ]}}{{α}^{[ 1 ]}} = {c}_{4}^{[ 1 ]} - ⌊ {c}_{4}^{[ 1 ]} ⌋$$

The position of the j-th run of order 1:
xⱼ^{[1]}=x₀^{[1]}+c₅^{[1]}+c₃^{[1]}−c₁^{[1]}
yⱼ^{[1]}=y₀^{[1]}+j

The length of the j-th run of order 1:
if c₅^{[1]}<c₂^{[1]}
   The length of the j-th run of order 1 is long, rⱼ^{[1]}=|τ^{[1]}|.
else
   The length of the j-th run of order 1 is short, rⱼ^{[1]}=└τ^{[1]}┘.

From Algorithm 1, the constants c₁^{[1]} and c₂^{[1]} can be calculated once in the initialization of the algorithm. The constants c₃^{[1]} and c₄^{[1]} can be calculated iteratively as each new parallel task is created from preexisting constants. Therefore each run can be set in parallel for a cost of approximately 6 additions, a multiplication and a comparison compared to a cost of 3 additions and two comparisons for the central loop of the sequential algorithm. Hence, the overhead imposed by the parallelization of the algorithm is quickly recouped.

Similarly, for an order 2 implementation as described in Algorithm 1, migrating to a parallel implementation would add two divisions and a multiplication to the cost of initializing the algorithm and 10 additions, a multiplication and division and a comparison to the cost of calculating the length and position of each run of order 2.

Algorithm 2 Calculating the Length and Position of the j-th Run of Order 2 in the Digital Line.

Constants pertaining to the line:

$${c}_{0}^{[ 2 ]} = \frac{{α}^{[ 1 ]}}{{α}^{[ 2 ]}}$$

$${c}_{1}^{[ 2 ]} = \frac{{β}_{0}^{[ 2 ]}}{{α}^{[ 2 ]}}$$

$${c}_{2}^{[ 2 ]} = \frac{{v}^{[ 2 ]}}{{α}^{[ 2 ]}}$$

Constants pertaining to the j-th run of order 1:

$${c}_{3}^{[ 2 ]} = j \frac{{α}^{[ 1 ]}}{{α}^{[ 2 ]}} = j * {c}_{0}^{[ 2 ]}$$

$${c}_{4}^{[ 2 ]} = \frac{{β}_{0}^{[ 2 ]} + j {μ}^{[ 2 ]}}{{α}^{[ 2 ]}} = {c}_{1}^{[ 2 ]} + {c}_{3}^{[ 2 ]} {μ}^{[ 2 ]}$$

$${c}_{5}^{[ 2 ]} = \frac{{β}_{j}^{[ 2 ]}}{{α}^{[ 2 ]}} = {c}_{4}^{[ 2 ]} - ⌊ {c}_{4}^{[ 2 ]} ⌋$$

if μ^{[1]}<v^{[1]}
   The length of the j-th run of order 2, shape 0: l⁺s:
   if c₅^{[2]}<c₂^{[2]}
      The length of the j-th run of order 2 is long, rⱼ^{[2]}=|τ^{[2]}|.
   else
      The length of the j-th run of order 2 is short, rⱼ^{[2]}=└τ^{[2]}┘. The height of the j full runs of order 2, shape 0: l⁺s:
         y=c₅^{[2]}+c₃^{[2]}−c₁^{[2]}
else
The length of the j-th run of order 2, shape 1: ls⁺:
if c₅^{[2]}<c₂^{[2]}
   The length of the j-th run of order 2 is short, rⱼ^{[2]}=└τ^{[2]}┘.
else
   The length of the j-th run of order 2 is long, rⱼ^{[2]}=|τ^{[2]}|.
The height of the j full runs of order 2, shape 1: ls⁺:
   y=c₅^{[2]}−c₃^{[2]}+c₁^{[2]}
The position of the j-th run of order 2 (xⱼ^{[2]}, yⱼ^{[2]})

$${x}_{j}^{[ 2 ]} = {x}_{0}^{[ 2 ]} + \frac{y + {β}_{j}^{[ 2 ]} - {β}_{0}^{[ 2 ]}}{{α}^{[ 1 ]}}$$

$${y}_{j}^{[ 2 ]} = {y}_{0}^{[ 2 ]} + y$$

Algorithm 3 Calculating the Length and Position of the j-th Run of Order i in the Digital Line.
Constants pertaining to the line:

$${c}_{0}^{[ i ]} = \frac{{α}^{[ i - 1 ]}}{{α}^{[ i ]}}$$

$${c}_{1}^{[ i ]} = \frac{{β}_{0}^{[ i ]}}{{α}^{[ i ]}}$$

$${c}_{2}^{[ i ]} = \frac{v [ i ]}{{α}^{[ i ]}}$$

Constants pertaining to the j-th run of order i:

$${c}_{3}^{[ i ]} = \frac{j}{{α}^{[ i ]}} = j {c}_{0}^{[ i ]}$$

$${c}_{4}^{[ i ]} = \frac{{β}_{0}^{[ i ]} + j {μ}^{[ i ]}}{{α}^{[ i ]}} = {c}_{1}^{[ i ]} + {c}_{3}^{[ i ]} {μ}^{[ i ]}$$

$${c}_{5}^{[ i ]} = \frac{{β}_{j}^{[ i ]}}{{α}^{[ i ]}} = {c}_{4}^{[ i ]} - ⌊ {c}_{4}^{[ i ]} ⌋$$

The type of the run of order i:
if μ^{[i-1]}<v^{[i-1]}
   t^{[i]}=0
else
   t^{[i]}=1

The shape of the run of order i:
s^{[i]}=t^{[i-1]}⊕t^{[i]}

The length of the j-th run of order i:
if t^{[i]}=0
   if c₅^{[i]}<c₂^{[i]}
      The length of the j-th run of order i is long, rⱼ^{[i]}=|τ^{[i]}|.
   else
      The length of the j-th run of order i is short, rⱼ^{[i]}=└τ^{[i]}┘.
else
   if c₅^{[i]}<c₂^{[i]}
      The length of the j-th run of order i is short, rⱼ^{[i]}=└τ^{[i]}┘.
   else
      The length of the j-th run of order i is long, rⱼ^{[i]}=|τ^{[i]}|.

The start point of the j-th run of order i:
pⱼ^{[i]}=j
for k=i−1 to 1
   if t^{[k]}=0
      pⱼ^{[k-1]}=α^{[k-1]}pⱼ^{[k]}/α^{[k]}+(βⱼ^{[k]}−β₀^{[k]})/α^{[k]}=c₀^{[k]}pⱼ^{[k]}+c₅^{[k]}−c₁^{[k]}
   else
      pⱼ^{[k-1]}=α^{[k-1]}pⱼ^{[k]}/α^{[k]}+(βⱼ^{[k]}−β₀^{[k]})/α^{[k]}=c₀^{[k]}pⱼ^{[k]}−c₅^{[k]}+c₁^{[k]}
      (xⱼ^{[i]},yⱼ^{[i]})=(pⱼ^{[0]}+x₀^{[i]},pⱼ^{[1]}+y₀^{[i]})
      Efficiency of Parallelization

To compare the efficiency of the parallel and sequential versions of the algorithms, we carry out an asymptotic analysis of the time complexity of the overall hierarchy algorithm for runs to all orders. At the outset we point out that we assume a rational slope α=a/d. We assume a and d are positive integers with a<d. For the case of an algebraic irrational slope α as described in the parent of the present application, a discussion of computing primitives would be required. However, given such a discussion, most of the rational slope analysis can be carried over to the algebraic irrational case. This follows because all of the operations involved in the algorithm are rational and it is well-known that equations and inequalities in algebraic irrational numbers involving explicitly rational (in fact algebraic) operations can be decided.

It has been shown in P. D. Stephenson and B. Litow, “Why step when you can run: Iterative line digitization algorithms based on hierarchies of runs”, IEEE Computer Graphics and Applications, 20(6):76-84, November/December 2000) that the number of orders in the hierarchy of runs for a line with slope ae is bounded above by O(log d) and that the number of runs in successive orders diminishes very much like partial quotients in the GCD algorithm for a and d. We will make use of this important observation in our analysis.

Initializations across orders are sequential, i.e., values for order i depend on values for order i−1. It is evident that at each order, initialization costs O(1) rational arithmetic operations. We emphasize that the division occurs only within the scope of the floor function. This suggests that the precision needed for division can be reduced considerably below the obvious requirement.

Within each order the computation of run lengths is actually an initialization and we count it as such. The run positions can be computed in parallel. Each position costs O(1) rational arithmetic operations. However, here division appears to require full precision. Assembling our accounting, we have that initialization over all orders costs O(log d) rational arithmetic operations. Idealizing slightly the partial quotients behavior of GCD, we credit order i with d/2ⁱ runs. If we allocate d/2ⁱ processors to the i-th run, the time to compute run positions across all orders is O(1) rational arithmetic operations. This gives a work (time × processors) value of O(d)·(1+1/2+ . . . +1/2^{h}), where h is the maximum order, h≦log d. This yields a work value of O(d). If we allocate fewer processors, the parallel time increases, but it should be possible to choose configurations that preserve the O(d) work value.

In computer graphics and even computational geometry applications of the algorithm, the value of d will probably remain below, say, 10⁴. The boundary condition here is the realization of the digitized line. In graphics the constraint that d<10⁴ seems realistic, since we would be resolving beyond 10⁸ pixels were d to exceed 10⁴. For computational geometry applications, more thought about implicit representations of digitized objects is needed. Using hierarchical run-based methods has shown a significant improvement in the cost to digitize a line. An important reason for the improvement has been the structural information of the digital line provided by its run-based description.

To implement a system based on one of the algorithms presented, the order of the algorithm must be decided either by the designer or dynamically by the system itself. While the length of the runs in the digital line increases exponentially with the order of the run, the cost of initializing an algorithm also rises, albeit linearly. Given that the cost of an iteration to decide the position and length of the next run in the line is so small, the number of runs in the line must be significant enough to warrant using a higher order algorithm.

Adding Anti-aliasing Pixels to Lines Drawn Using Runs

Anti-aliasing Generally

The resolution of many display devices remains insufficient to hide aliasing effects from the human visual system. Aliasing occurs during digitization of a continuous function such as a line, when the function cannot be sampled at a rate at least twice that of its highest component frequency. Artifacts introduced into the resultant digital representation take the form of jagged edges, scintillation of small moving primitives, and the non-uniform intensity of edges across all rotations. To reduce the visual impact of aliasing artifacts, several techniques for anti-aliasing an image have been proposed. In all of them, a line is given a width (for example, one pixel) and when a pixel has a portion within the line, the pixel is given the line's color with an intensity that is a function of the amount of the pixel that is within the line.

A common technique for determining the intensity of anti-aliasing pixels for applications such as line drawing is to employ a filter such as the box filter, which can be easily incorporated into a pixel-based line drawing algorithm and implemented in hardware. The box filter, based on area sampling, determines the fraction of a pixel covered by the line but has far from optimal frequency response. The frequency response can be improved by convolving the box filter with a triangle or cone filter.

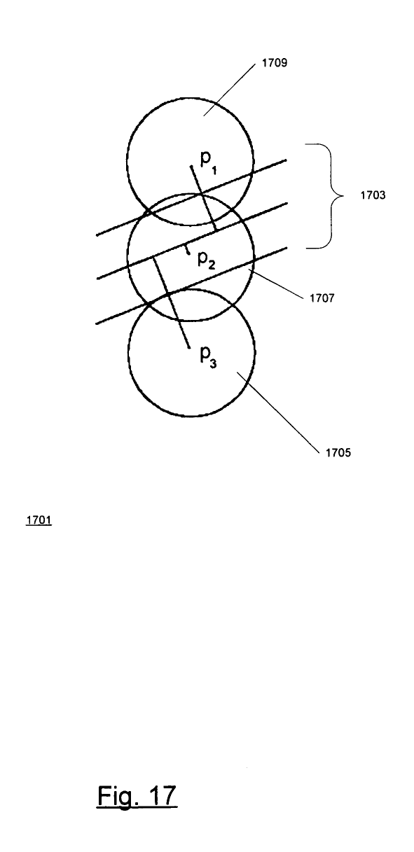

Regardless of the filter used, if the filter is circularly symmetric, using a look-up table can reduce the amount of computation required. Gupta and Sproull pre-computed the values of a cone filter of radius one and stored them in a table indexed by the perpendicular distance from a pixel center to the center of the ideal line. See S. Gupta and R. Sproull. Filtering edges for gray-scale displays. Computer Graphics (SIGGRAPH '81 proceedings), 15(3), Aug. 1981, pp. 1-5. For each major axis step in the set of cells representing the line, Gupta and Sproull intensified 3 pixels, as shown in FIG. 17. At 1703 is shown the line; the three pixels are shown at 1705, 1707, and 1709. Since pixel 1705 is barely intercepted by the line, it will have the lowest intensity; pixel 1707 has the largest portion of its area in the line, so it will have the highest intensity, while the intensity of 1709 will lie between those extremes.

Gupta and Sproull found that only for extreme cases would more than three pixels be needed to anti-alias a line of unit thickness. The extension to lines of non-unit width, however, can be made.

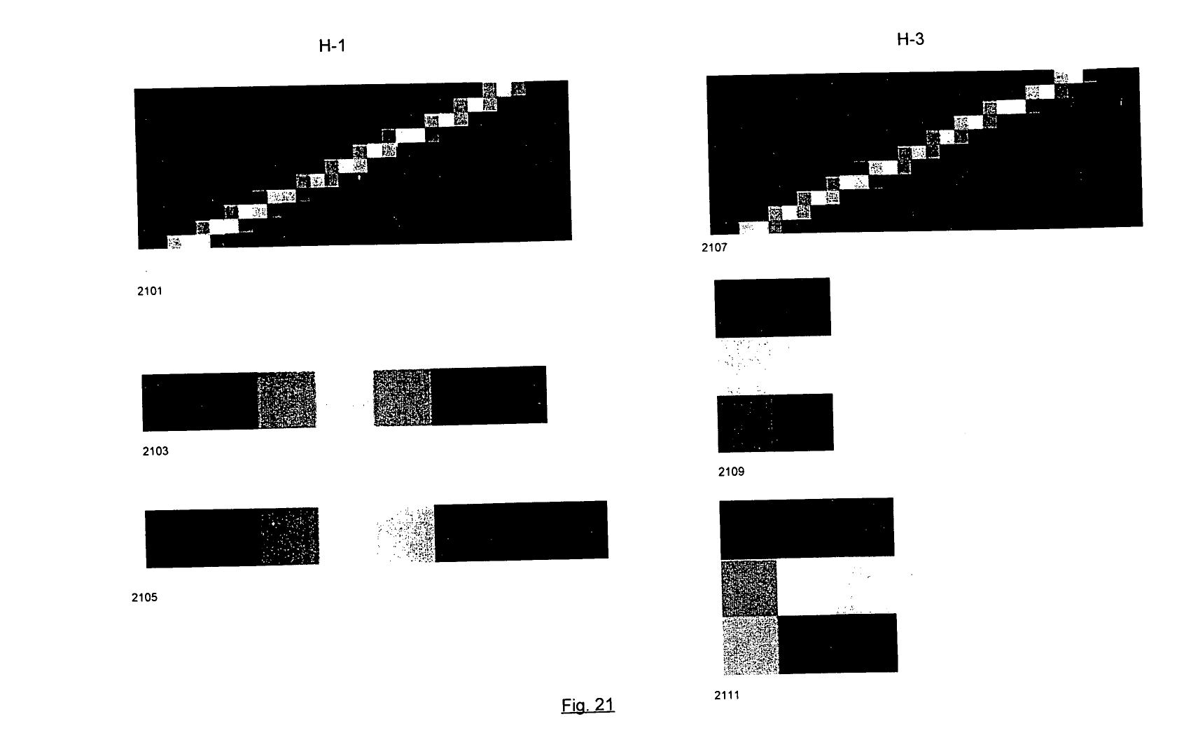

Anti-aliasing with Run Masks: FIG. 21

The structural information acquired in the course of drawing lines using runs of pixels can be used to accelerate anti-aliasing. This is done by defining and precomputing a number of run masks describing the anti-aliased pixel intensities for the one or two run lengths used in drawing the line. Once the run masks are defined, the line can be drawn using the run masks in place of their corresponding run lengths. As with the run lengths, which run mask to use at a given point in the line can be determined from the structural information and run masks may be set in parallel. The intensities of the pixels in the run masks can be determined using any pre-filtering technique. Run masks offer a significant reduction in the cost of drawing the line and the results obtained are little different from those obtained by doing anti-aliasing a pixel at a time. Given the length of the lines we will consider and the fact that in most applications the hierarchical runs must be broken down into pixels or runs of pixels when the runs are set, we will concentrate our discussion on run masks consisting of runs of pixels. However extending these ideas to higher order runs is straightforward.

To draw an anti-aliased line using higher order run masks, one or more higher-order run masks must be defined for each higher-order run length. The higher-order run mask could be defined as a bitmap or a recursive description of lower-order run masks.

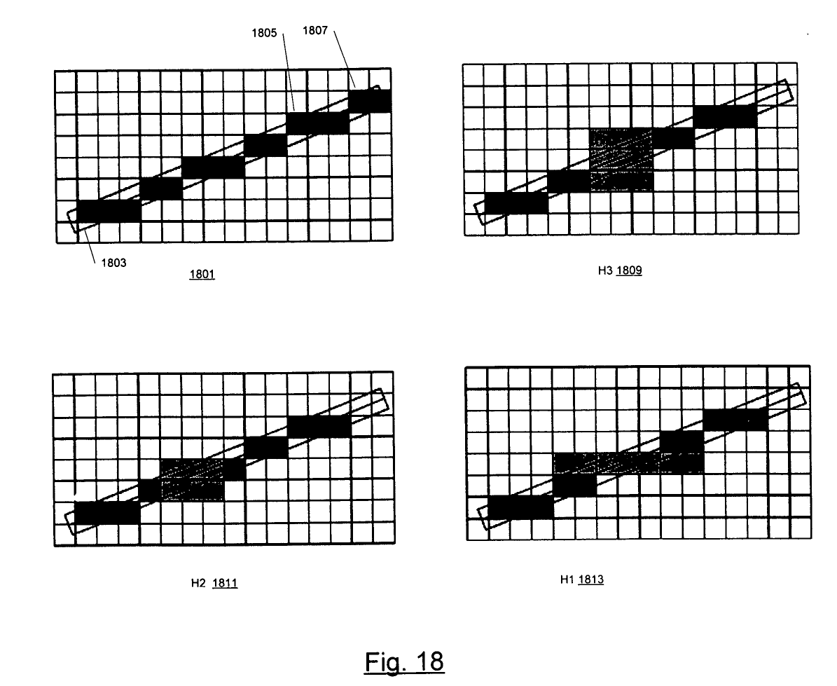

The run masks can have various shapes and the pixels in them can have varying intensities. FIG. 18 shows three examples. As shown at 1801, the exemplary run masks are to be applied to a line of unit width 1803. The order 1 runs for the line include one of 3 pixels (1805) and another of two pixels (1807). The exemplary run masks include the Height-3 (H3) mask shown at 1809, the couplet Height-2 mask (H2) shown at 1811, and the Height-1 mask (H1) shown at 1813.

Each is constructed by extending the run length calculated by the line drawing algorithm to cover the neighboring pixels affected by a line of unit width. When the masks are applied to each of the runs, each of the pixels affected by the line will have an intensity governed by the portion of the pixel that is within the line of unit width.

H3 mask 1809 is based on the observation of Gupta and Sproull that no more than three pixels per column have to be intensified per major axis step in order to anti-alias a line of unit thickness. As shown at 1809, the H3 mask includes both the run of pixels calculated using the run-based line drawing algorithm and the runs immediately above and below this run, thereby covering the pixels that should be intensified using the three pixel per column idea.

H1 mask 1813 achieves the same goal as the H3 mask by extending the length of each run. Thus, the mask is only one pixel high, but its length is increased to cover the pixels above the previous and below the next run in the line.

H2 mask 1811 takes a slightly different approach from the other two. Instead of extending a single run, a H2 mask extends two adjoining runs to cover the major axis step. Therefore at least four basic masks are required not just two. The H2 masks are defined for every pair of run lengths: short-short, short-long, long-short and long-long. The maximum height in pixels provided by a sequence of H2 run mask is two pixels, and the H2 run mask therefore offers less complete coverage of the unit line than the other styles of run mask.

FIG. 21 shows examples of a line drawn using the H1 and H3 masks and of long and short masks for the line. The values of the pixels for the line drawn using the H1 mask is shown at 2101; an H1 mask for a short run of order 1 is shown at 2103; an H1 mask for a long run of order 1 is shown at 2105. The values of the pixels for the same line drawn using the H3 mask are shown at 2107; an H3 mask for a short run of order 1 is shown at 2109; an H3 mask for a long run of order 1 is shown at 2111.

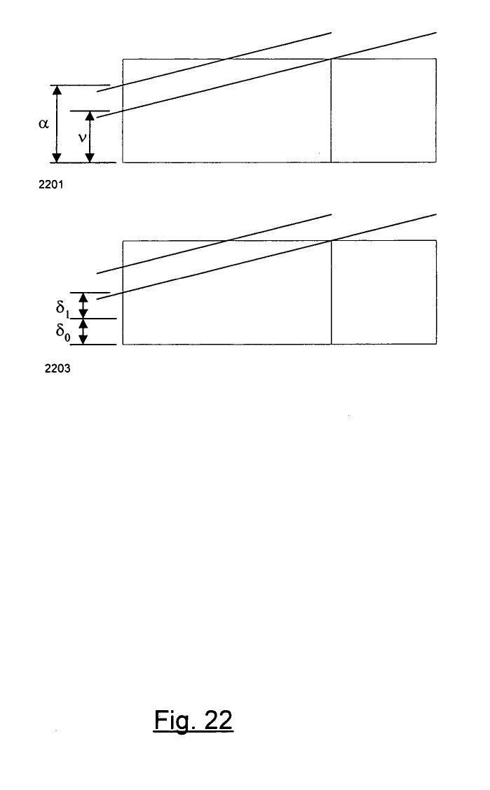

Computing Pixel Intensities in the Run Masks: FIG. 22

Any pre-filtering algorithm used in anti-aliasing can be adapted to compute the intensities of the pixels in the run masks. Run masks can be constructed for any level of the hierarchy of runs in the digital line, however we will concentrate on run masks defined as runs of pixels. The ideas we describe can be easily extended to higher order runs.

As explained in the parent of the present patent application, structural parameters for a line may be used to determine lengths of runs. These structural parameters α, β, and ν are shown in FIG. 15. To calculate each run mask, we will use a pixel-based approach based on a look-up table of pre-filtered pixel intensities. One of the structural parameters, the intercept value β, is used to index the look-up table of pixel intensities when pre-calculating the run mask. The main decision in defining the run mask lies in where to initially place the continuous line relative to the run such that the run mask generated is representative of the pixel intensities that exist in runs of that length in the digital line. This can be achieved by carefully choosing for each mask the initial intercept value, β₀.

In the simplest case where only one run mask is used for each long and short run, we can choose an initial intercept value β₀ that lies in the middle of the range of intercept values that defines each run length. We know that the intercept values for a line are evenly distributed over the range 0≦βⱼ<α for a line of infinite length, where oa is the slope of the line. Therefore to define the run mask associated with a long run, the line is placed at the position

$${β}_{0} = \frac{v}{2}$$

and the run mask is pre-computed. ν is another one of the structural parameters shown in FIG. 15. For a short run, the line is placed at the position

$${β}_{0} = \frac{α + v}{2}$$

The starting and ending points of the line segment form a boundary on the run structure of the line that can cause truncation of the first and/or last runs of the line. The separate calculation of additional first and last run masks can be avoided by observing that truncated run masks can be constructed directly from either the short or long run masks.

To reduce the disparity between the final images generated by using run masks and the pre-filtering technique itself, more than one run mask can be defined for each run length, with the choice of run mask for the run length being again based on the value of β₀. We found this particularly useful for lines of slope between one half and one. The majority of the visual errors introduced by using run masks occur at the boundary between runs. Therefore, the more runs in the line, the less visually appealing the image. By using only two run masks for each run length for lines in the range one half to one, a dramatic improvement in visual quality can be achieved. The cost of pre-calculating the extra runs masks is very low because the runs are so short.

FIG. 22 presents an example of how to use multiple run masks for each run length. As shown at 2201, a long run is set if the value of the intercept, βⱼ, is 0≦βⱼ<ν and short if ν≦βⱼ<α. Since there is only one run mask for each short run in the line, whenever the intercept value is ν≦βⱼ<α, the single short run-mask is used. If the intercept value is 0≦βⱼ<ν and a long run is to be set, one of the long run masks is used if the intercept value is in the range δ₀ and the other if it is in the range δ₁, as shown at 2203.

Quality of the Anti-aliasing

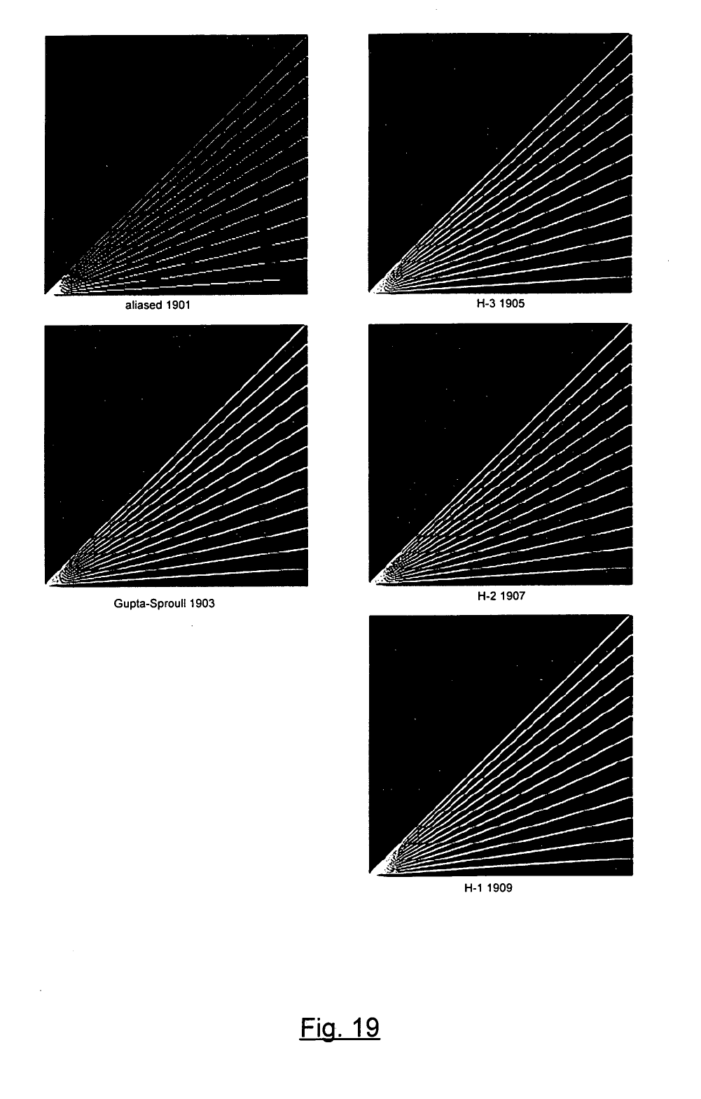

The quality of anti-aliasing in any image is often subjective and difficult to quantify. Therefore, we have followed the example of others and included FIG. 19, which shows the output of the lines produced by using the H1 (1909), H2 (1907), and H3 (1905) run masks. These results can be compared to the minimal 8-connected line shown at 1901 and lines shown at 1903 that were produced solely by applying the pre-filtering technique used to construct the run masks, which in this case was the Gupta-Sproull algorithm. It should be noted that gamma correction has been applied to the final images.

In order to measure the error introduced to the anti-aliased line representation by using run masks we also calculated the mean pixel-by-pixel error as measured against the pre-filtering technique used, which was again the Gupta-Sproull algorithm. The mean pixel-by-pixel error was calculated for every possible line with slope in (0,1] defined within a 512×512 lattice. The results are given in Table 1 below.

The H1 mask performs the most accurately, with just a 3.9% error, followed by the H3 mask with a 4.3% error. The H2 masks have a 6.2% error. These results are mirrored in the visual output shown in FIG. 19, as it can clearly be seen that the H2 lines contain more aliasing errors than either the H1 or H3 lines. The H2 run masks produce a worse mean error compared with the other mask shapes because they do not permit a comprehensive coverage of the line. Also, multiple masks per run length were not implemented for the H2 masks.

TABLE 1
Comparison of the mean pixel-by-pixel errors of the run-based and the
Gupta-Sproull algorithms.

| Mean Pixel Error (MPE) | Height-1 | Height-2 | Height-3 |
|---|---|---|---|
| Mean of MPE for lines in (0, 1] | 3.9% | 6.2% | 4.3% |
| Maximum MPE for lines in (0, 1] | 11.0% | 12.9% | 10.5% |
| Standard Deviation of MPE for lines | 2.1% | 3.0% | 2.6% |
| in (0, 1] | | | |

Efficiency of Run Masks

The following discussion of the efficiency gains resulting from the use of run masks is based on the results presented by Stephenson and Litow in Stephenson and Litow, Why step when you can run: Iterative line digitization algorithms based on hierarchies of runs, IEEE Computer Graphics and Applications, 20(6), November-December 2000, pp. 76-84 for run-based algorithms. For a minimal 8-connected line, the time complexity of the pixel-based line drawing algorithm is O(n) where n is the number of pixels in the line. The time complexity of the run-based line drawing algorithm is O(n/τ) where τ is the average run length in the line. For an anti-aliased line, if we consider that the complexity of calculating a run mask is O(τ) and assume that the run masks are pre-calculated for each line, the complexity of the run mask algorithm is O(τ+n/τ). Therefore as the slope of the line approaches one or zero, the algorithm tends to O(n).

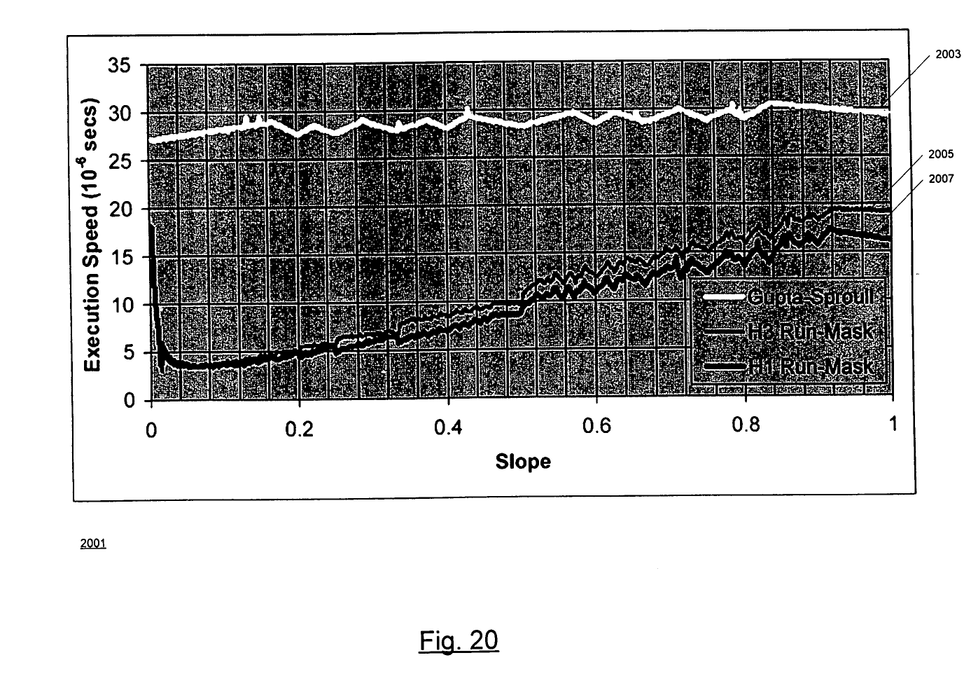

In practice, however this does not necessarily mean that the algorithm is slower than a pixel-based algorithm as the pixel algorithm must process three pixels per iteration. This effect can be seen in FIG. 20, in which graph 2001 describes the results of a wall-clock experiment that timed the scan conversion of lines of length 512 pixels between a slope of 0 and 1. Each line was rendered 500 times. While wall clock experiments can only be considered qualitative, the higher costs of using run masks for lines of slope near zero and the dependency on the slope of the line are both evident. For a 512-pixel line, however, run masks everywhere offer significant improvement over a pixel-based algorithm.

The length of a line plays an important role in determining the order of runs to use for a line drawing algorithm. The cost of initializing the run masks and the run-based digitization algorithm dictate that for very short lines, using run masks makes little sense. The cost of initialization however is quickly recouped as the length of the line increases. The differences between the costs of using H1, H2 or H3 run masks are a result of the cost of pre-calculating the run masks. If H2 masks are used, there are four masks in the simplest case instead of two. The H1 mask also gains a slight advantage over the H3 mask for lines of small slope.

Using run masks in run-based line drawing algorithms can significantly reduce the costs of producing an anti-aliased line in many applications while giving a visual quality that does not greatly differ from that provided by pixel-based algorithms. The run mask idea can be applied to algorithms based on runs of runs, run length slices, or any other higher order run, either by defining run masks for the higher orders or by setting run masks defined as runs of pixels. The choice of which order to use must, however, be made individually for each application as the costs of initializing each new level of the algorithm dictates that for short lines, lower order algorithms are more efficient.

In the simplest implementation only one run mask is used for each run length in the line, of which there are at most two. Offering more than one run mask per run length can quickly improve the visual quality of the final anti-aliased line. The majority of visual artifacts can be seen at the boundary between runs; therefore as the slope of the line approaches one and the number of runs in the line increases, the visual quality of the anti-aliasing starts to decrease.

The style of the mask chosen dictates the cost of its computation. Both the H1 and H3 mask pre-computation are more efficient than the H2 since only two run masks are computed rather than four. The H1 mask is also faster to compute than the H3 mask because some arithmetic operations are avoided as a result of the simpler mask geometry. The H1 mask gains an additional advantage in the drawing stage of the algorithm in that it is completely coherent to the layout of the raster memory and thus requires only one memory operation in comparison to the three required by the H3 mask.

Using Structural Information About a Line to Take Advantage of Memory Operations that Permit Multiple Pixels to be Written at Once

Where the hardware provides a memory operation that permits multiple pixels to be written at once, techniques closely related to those used with anti-aliasing can be used to write runs which are contained partially or entirely in the sets of multiple pixels that can be simultaneously written. The starting position of the run can be computed from the end of the last run and the structure parameters give the run's length, and thus, the portion of the run that is within the set of multiple pixels can be determined and the multiple pixels set up so that the pixels in the portion of the run that is within the set of multiple pixels can be set as required for the line and the remainder set as required for the line's background, whereupon all of the pixels can be written at once. The same technique can be used to write anti-aliasing masks as well as runs.

Writing a Line Using Anti-aliasing Masks and/or and sets of Multiple Pixels in Parallel

A line that is written using anti-aliasing masks or by writing sets of multiple pixels can of course be written in parallel in the same fashion as was explained above for writing runs in parallel. Instead of computing the position of each run and writing the runs in parallel, one computes the position of each run mask or each set of multiple pixels and then writes the masks or sets of multiple pixels in parallel.

### CONCLUSION

The foregoing Detailed Description has disclosed to those skilled in the relevant technologies the inventors' techniques for using structural information concerning the pixels that are intersected by a line to increase the efficiency of line drawing and has further disclosed the best modes presently known to the inventors of employing the techniques.

As disclosed, the techniques include using the structural information to determine sets of cells of a lattice, which may be processed in parallel and using the structural information to determine sets of cells that include the run and cells additional thereto. The latter technique includes using the structural information to determine the locations and pixel values of anti-aliasing pixels and using the structural information to determine how multi-pixel chunks of memory are to be read or written.

It will however be immediately apparent to those skilled in the relevant technologies that applications of the principles of the invention other than those disclosed herein are possible; it will further be apparent that other implementations of the techniques of the invention may employ structural information which has forms different from the structural information disclosed herein. For example, the use of two structural parameters in the preferred embodiment is simply a matter of design choice, since each of the structural parameters can be derived from the other. What is important is thus not the specific forms of the error terms and structural parameters disclosed herein, but rather the relationships between the characteristics of the runs of a particular order and the error term and structural parameters for that order as well as the use of the structural parameters of one order to determine the type of the next order and the use of the error term of one order together with the type to determine the length and error term of a truncated run of the next order. Further, though the examples disclosed herein involve the construction of pixel representations of lines, the techniques may be used in any situation where it is useful to determine what cells of a lattice are intersected by a given lire.

Since this is so, the Detailed Description is to be regarded as being in all respects exemplary and not restrictive, and the breadth of the invention disclosed here in is to be determined not from the Detailed Description, but rather from the claims as interpreted with the full breadth permitted by the patent laws.

1. A method of making a determination in a lattice of a first set of cells of the lattice that are intersected by a line, the lattice being represented in memory accessible to a processor and the determination being done in the processor according to a technique that employs runs of cells,
the method comprising:
an initialization step wherein the processor determines the starting positions of a plurality of second sets of cells of the lattice, each second set including at least a full run of the cells; and
a determination step wherein the processor makes the determinations for the plurality of second sets in parallel.

2. The method set forth in claim 1 wherein
the technique employs orders 1 . . . n of runs of cells, the initialization step comprises the steps of:
deriving an error term and a structural parameter for order 1 using the values of the coordinates for the line's end points and
performing the step beginning with order 2 for each order 1,2≦i≦n of
determining an error term and a structural parameter for the order i using the error term and structural parameter from order i−1; and
using the error term and the structural parameter for the order n to determine positions of a plurality of the second sets of cells which include at least full runs of order n.

3. The method set forth in claim 1 wherein:
the runs of cells belong to an order n>1; and
in the initialization step, each second set includes at least a full run of order i, where 1≦i<n in the run of order n.

4. The method set forth in claim 1 wherein:
the second sets further include additional cells that are affected when a cell is intercepted by a line.

5. A method of processing cells in a lattice that are affected when a line is drawn in the lattice, the lattice being represented in memory accessible to a processor, the line being drawn by the processor, and the cells that are intersected by the line being determined according to a technique that uses runs of cells, each run having either a short length or a long length and
the method comprising the steps of:
determining for each length of run a set of cells including one or more cells of the run and cells additional thereto that are affected when the line is drawn; and
when the line is drawn, processing the cells in the set as required by the run's length.

6. The method set forth in claim 5 wherein:
the additional cells are anti-aliasing cells.

7. The method set forth in claim 6 wherein:
The number and location of the anti-aliasing cells relative to the cells of the run is determined by the run's length.

8. The method set forth in claim 6 wherein:
the values for the pixels in the anti-aliasing cells are determined by the run's length.

9. The method set forth in claim 8 wherein:
associated with each run is an error term β that indicates where the line intersects the leading edge of the first cell in the run; and
the method further comprises the step of:
determining the values of the pixels in the anti-aliasing cells according to a plurality of ranges of the value of β; and
in the step of processing the additional cells, the anti-aliasing cells are further given values as determined by the range to which β belongs for the run.

10. The method set forth in claim 9 wherein:
the processor has access to a table which relates ranges of values of β to sets of pixel values for anti-aliasing cells; and
in the step of processing the additional cells, the table is used to give the anti-aliasing cells values.

11. The method set forth in claim 6 wherein:
the anti-aliasing cells are added to the ends of the run.

12. The method set forth in claim 6 wherein:
the anti-aliasing cells are added above and/or below the run.

13. The method set forth in claim 12 wherein:
the anti-aliasing cells are added either above or below the run.

14. The method set forth in claim 12 wherein:
the anti-aliasing cells are added both above and below the run.

15. The method set forth in claim 6 wherein:
the cells of the raster correspond to locations in the processor's memory, each location containing the value of a pixel;
the processor reads and/or writes the memory in chunks that contain a plurality of pixels; and
the additional cells further include cells that neither belong to the run nor belong to the anti-aliasing cells, but do belong to a chunk that includes at least a cell of the run and/or an anti-aliasing cell.

16. The method set forth in claim 5 wherein:
the cells of the raster correspond to locations in the processor's memory, each location containing the value of a pixel;
the processor reads and/or writes the memory in chunks that contain a plurality of pixels; and
the additional cells are cells in a chunk that includes at least one cell of the run.

17. The method set forth in claim 5 further comprising the steps of:
an initialization step wherein the starting positions and lengths of the sets of cells are determined by the processor; and
when the line is drawn, processing of the plurality of sets of cells is done in parallel.

18. The method set forth in claim 5 wherein:
the technique employs orders 1 . . . n of runs of cells,
the initialization step comprises the steps of:
deriving an error term and a structural parameter for order 1 using the values of the coordinates for the line's end points and
performing the step beginning with order 2 for each order i, 2≦i≦n of
determining an error term and a structural parameter for the order i using the error term and structural parameter from order i−1; and
using the error term and the structural parameter for the order n to determine positions of a plurality of the sets of cells.

19. The method set forth in claim 2 wherein:
the second sets further include additional cells that are affected where a cell is intercepted by a line.

20. The method set forth in claim 3 wherein:
the second sets further include additional cells that are affected where a cell is intercepted by a line.
